(19) United States
(12) Patent Application Publication
(10) Pub. No.: US 2018/0367288 A1
(43) Pub. Date: Dec. 20, 2018

(54) DYNAMIC ACTIVATION AND DEACTIVATION OF PACKET DUPLICATION

(71) Applicants: Sophie Vrzic, Kanata (CA); Jaya Rao, Ottawa (CA)

(72) Inventors: Sophie Vrzic, Kanata (CA); Jaya Rao, Ottawa (CA)

(73) Assignee: Huawei Technologies Co., Ltd., Shenzhen (CN)

(21) Appl. No.: 15/947,371

(22) Filed: Apr. 6, 2018

Related U.S. Application Data
(60) Provisional application No. 62/521,229, filed on Jun. 16, 2017.
(60) Provisional application No. 62/608,118, filed on Dec. 20, 2017.

(51) Int. Cl. H04L 5/00; H04L 12/46; H04L 1/18; H04L 12/927; H04W 36/22; H04W 76/12; H04W 28/06; H04W 28/02; H04W 88/06

(52) U.S. Cl. CPC H04L 5/0098; H04L 12/4633; H04L 1/189; H04L 47/805; H04W 88/06; H04W 76/12; H04W 28/06; H04W 28/0268; H04W 36/22

(57) ABSTRACT

A method at a network node of a Radio Access network (RAN) for controlling packet duplication. The method includes: receiving, via at least one network interface of the network node, information indicative of a quality of each one of at least two radio channels including a first radio channel between a User Equipment and a master node and a second radio channel between the User Equipment and a secondary node; determining, based on the received information, a respective splitting flag value associated with each of the master and secondary nodes; and controlling packet duplication based on the respective splitting flag value associated with each of the master and secondary nodes.

### CROSS REFERENCE TO RELATED APPLICATIONS

This application is related to U.S. provisional patent application No. 62/521,229, filed Jun. 16, 2017, and U.S. provisional patent application No. 62/608,118, filed Dec. 20, 2017 the entire content of both of which is incorporated herein by reference.

### FIELD OF THE INVENTION

The present invention generally pertains to the field of Communications Networks, and particular embodiments or aspects relate to dynamic activation and deactivation of packet duplication.

### BACKGROUND

The third Generation Partnership Project (3GPP) has defined standards that support methods of packet duplication of Uplink and Downlink packets between nodes of the Radio Access Network and User Equipment. These methods provide only limited control over the packet duplication function.

Accordingly, there may be a need for a system and method for downlink transmission in a RAN inactive mode that is not subject to one or more limitations of the prior art.

This background information is intended to provide information that may be of possible relevance to the present invention. No admission is necessarily intended, nor should be construed, that any of the preceding information constitutes prior art against the present invention.

### SUMMARY

It is an object of the present invention to obviate or mitigate at least one disadvantage of the prior art.

Accordingly, an aspect of the present invention provides a method at User Equipment (UE) for controlling packet duplication of a Radio Access network (RAN) having DC architecture, the method comprising: receiving, via at least one network interface of the User Equipment, information indicative of an event triggered at a master node and an event triggered at a secondary node; and performing packet duplication contingent on the received information, and reliability requirements.

A further aspect of the present invention provides a method at User Equipment (UE) for controlling packet duplication of a Radio Access network (RAN) having CA architecture, the method comprising: receiving, via at least one network interface of the User Equipment, information indicative of an event triggered at a node; and performing packet duplication contingent on the received information.

### BRIEF DESCRIPTION OF THE FIGURES

Further features and advantages of the present invention will become apparent from the following detailed description, taken in combination with the appended drawings, in which:

FIG. 1 is a block diagram of an electronic device 52 within a computing and communications environment 50 that may be used for implementing devices and methods in accordance with representative embodiments of the present invention;

FIG. 2 is a block diagram illustrating an example architecture of a 5G Radio Access Network;

FIG. 3 is a block diagram illustrating an example Radio Link Protocol Stack usable in embodiments of the present invention;

FIG. 4A is a block diagram illustrating Dual Connection architecture;

FIG. 4B is a block diagram illustrating a Protocol Stack for the Dual Connection architecture of FIG. 4A;

FIGS. 5A and 5B are block diagrams illustrating respective example functional system architectures usable in embodiments of the present invention;

FIG. 6 is a block diagram illustrating packet duplication in accordance with an example embodiment of the present invention;

FIG. 7 is a table showing representative rules for controlling packet duplication in accordance with an example embodiment of the present invention;

FIG. 8 is a table showing representative splitting flag values in accordance with an example embodiment of the present invention;

FIG. 9 is a block diagram illustrating an example functional system architecture for make before break handover with packet duplication in accordance with an example embodiment of the present invention;

FIGS. 10A and 10B illustrate respective functions performed in transmitting and receiving PDCP entities in the UE in accordance with an example embodiment of the present invention;

FIG. 11 is a block diagram illustrating a representative layer 2 structure for uplink packets with Dual Connection configured for packet duplication in accordance with an example embodiment of the present invention;

FIG. 12A is a block diagram illustrating an example functional system architecture for make-before-break handover with DL packet duplication in the MgNB;

FIG. 12B is a block diagram illustrating an example functional system architecture for make-before-break handover with DL packet duplication in the Core Network;

FIG. 13 is a block diagram illustrating packet duplication in a Channel Aggregation architecture in accordance with an example embodiment of the present invention;

FIG. 14 is a block diagram illustrating packet duplication in a combined Dual Connection and Channel Aggregation architecture in accordance with an example embodiment of the present invention;

FIG. 15 is a block diagram illustrating packet duplication in a combined Dual Connection and Channel Aggregation architecture in accordance with an example embodiment of the present invention;

FIG. 16 is a message flow diagram illustrating a representative process for controlling packet duplication in accordance with an example embodiment of the present invention.

FIG. 17 illustrates a representative packet duplication MAC CE sub-header;

FIG. 18 is a table showing representative UE operations for “AND” operation and “OR” operations in accordance with an example embodiment of the present invention;

FIG. 19 is a table showing representative requirements for link selection for different UE and network implementation options, in accordance with an example embodiment of the present invention;

FIG. 20 illustrates another representative packet duplication MAC CE sub-header;

FIG. 21 is a table illustrating an effect of path redundancy on reliability;

FIG. 22 is a table illustrating options for redundancy in the RAN and/or the CN;

FIG. 23 is a block diagram illustrating an example solution for providing redundancy in the RAN;

FIG. 24 is a block diagram illustrating another example solution for providing redundancy in the RAN;

FIGS. 25A and 25B are a block diagrams illustrating example solutions for providing redundancy in the CN;

FIGS. 26A and 26B are a block diagrams illustrating Dynamic Control of Packet Duplication in DC Option 1A;

FIGS. 27A and 27B are message flow diagrams illustrating UL Transmission in DC Architecture 1A, with and without PD;

FIG. 28 is a message flow diagrams illustrating DL Transmission in DC Architecture 1A, with and without PD;

FIG. 29 is a table showing example contents of a UL MAC CE;

FIG. 30 is a block diagram illustrating example protocol stacks at the UE, MgNB, SgNB and UPF;

FIG. 31 is a block diagram illustrating example mapping of duplicate QoS flows to N3 tunnels and DRBs;

FIG. 32 is a block diagram illustrating example mapping DL URLLC Transmission and QoS Flow Mapping;

FIG. 33 is a block diagram illustrating example UL URLLLC Transmission and QoS Flow Mapping;

FIG. 34 is a block diagram illustrating example packet duplication and removal by the application in the UE and AS;

FIG. 35 is a block diagram illustrating example packet duplication and removal at the UE and UPF;

FIG. 36 is a block diagram illustrating example packet duplication Using DC Architecture Options 1A and 3C;

FIG. 37 is a block diagram illustrating example URLLC transmission with two UPFs for redundancy; and

FIGS. 38A and 38B are message flow diagrams illustrating example processes for PDU session establishment and modification, respectively.

### DETAILED DESCRIPTION

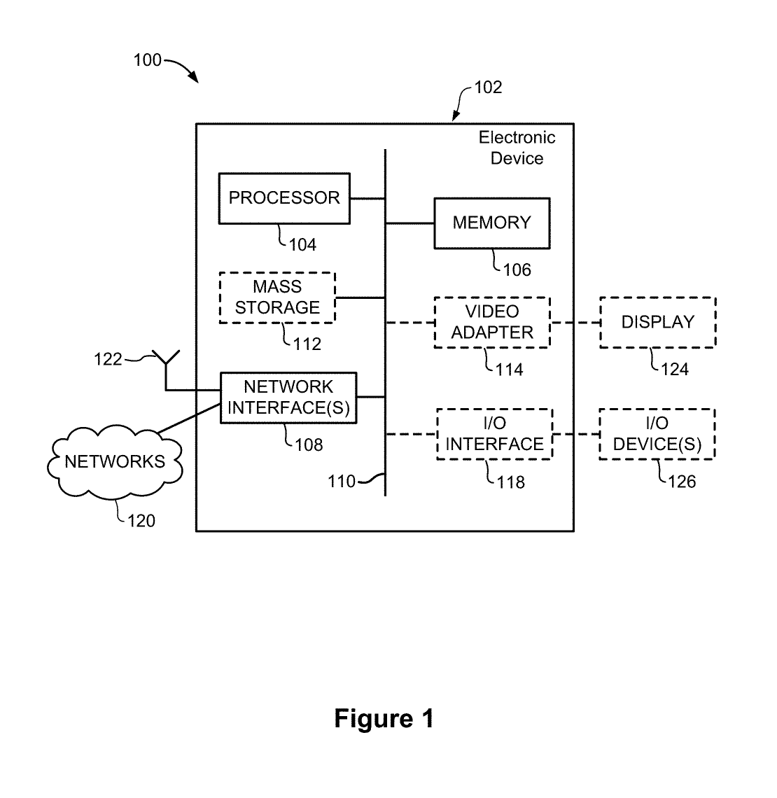

FIG. 1 is a block diagram of an electronic device (ED) 102 illustrated within a computing and communications environment 100 that may be used for implementing the devices and methods disclosed herein. In some embodiments, the electronic device may be an element of communications network infrastructure, such as a base station (for example a NodeB, an enhanced Node B (eNodeB), a next generation NodeB (sometimes referred to as a gNodeB or gNB), a home subscriber server (HSS), a gateway (GW) such as a packet gateway (PGW) or a serving gateway (SGW) or various other nodes or functions within an evolved packet core (EPC) network. In other embodiments, the electronic device may be a device that connects to network infrastructure over a radio interface, such as a mobile phone, smart phone or other such device that may be classified as a User Equipment (UE). In some embodiments, ED 102 may be a Machine Type Communications (MTC) device (also referred to as a machine-to-machine (m2m) device), or another such device that may be categorized as a UE despite not providing a direct service to a user. In some references, an ED may also be referred to as a mobile device, a term intended to reflect devices that connect to mobile network, regardless of whether the device itself is designed for, or capable of, mobility. Specific devices may utilize all of the components shown or only a subset of the components, and levels of integration may vary from device to device. Furthermore, a device may contain multiple instances of a component, such as multiple processors, memories, transmitters, receivers, etc. The electronic device 102 typically includes a processor 104, such as a Central Processing Unit (CPU), and may further include specialized processors such as a Graphics Processing Unit (GPU) or other such processor, a memory 106, a network interface 108 and a bus 110 to connect the components of ED 102. ED 102 may optionally also include components such as a mass storage device 112, a video adapter 114, and an I/O interface 118 (shown in dashed lines).

The memory 106 may comprise any type of non-transitory system memory, readable by the processor 104, such as static random access memory (SRAM), dynamic random access memory (DRAM), synchronous DRAM (SDRAM), read-only memory (ROM), or a combination thereof. In an embodiment, the memory 106 may include more than one type of memory, such as ROM for use at boot-up, and DRAM for program and data storage for use while executing programs. The bus 110 may be one or more of any type of several bus architectures including a memory bus or memory controller, a peripheral bus, or a video bus.

The electronic device 102 may also include one or more network interfaces 108, which may include at least one of a wired network interface and a wireless network interface. As illustrated in FIG. 1, network interface 108 may include a wired network interface to connect to a network 120, and also may include a radio access network interface 122 for connecting to other devices over a radio link. When ED 102 is network infrastructure, the radio access network interface 122 may be omitted for nodes or functions acting as elements of the Core Network (CN) other than those at the radio edge (e.g. an eNB). When ED 102 is infrastructure at the radio edge of a network, both wired and wireless network interfaces may be included. When ED 102 is a wirelessly connected device, such as a User Equipment, radio access network interface 122 may be present and it may be supplemented by other wireless interfaces such as WiFi network interfaces. The network interfaces 108 allow the electronic device 102 to communicate with remote entities such as those connected to network 120.

The mass storage 112 may comprise any type of non-transitory storage device configured to store data, programs, and other information and to make the data, programs, and other information accessible via the bus 110. The mass storage 112 may comprise, for example, one or more of a solid state drive, hard disk drive, a magnetic disk drive, or an optical disk drive.

In some embodiments, mass storage 112 may be remote to the electronic device 102 and accessible through use of a network interface such as interface 108. In the illustrated embodiment, mass storage 112 is distinct from memory 106 where it is included, and may generally perform storage tasks compatible with higher latency, but may generally provide lesser or no volatility. In some embodiments, mass storage 112 may be integrated with a heterogeneous memory 106.

The optional video adapter 114 and the I/O interface 118 (shown in dashed lines) provide interfaces to couple the electronic device 102 to external input and output devices. Examples of input and output devices include a display 124 coupled to the video adapter 114 and an I/O device 126 such as a touch-screen coupled to the I/O interface 118. Other devices may be coupled to the electronic device 52, and additional or fewer interfaces may be utilized. For example, a serial interface such as Universal Serial Bus (USB) (not shown) may be used to provide an interface for an external device. Those skilled in the art will appreciate that in embodiments in which ED 102 is part of a data center, I/O interface 118 and Video Adapter 114 may be virtualized and provided through network interface 108.

In some embodiments, electronic device 102 may be a standalone device, while in other embodiments electronic device 102 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources may take the form of physical connections such as Ethernet or optical communications links, and in some instances may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created.

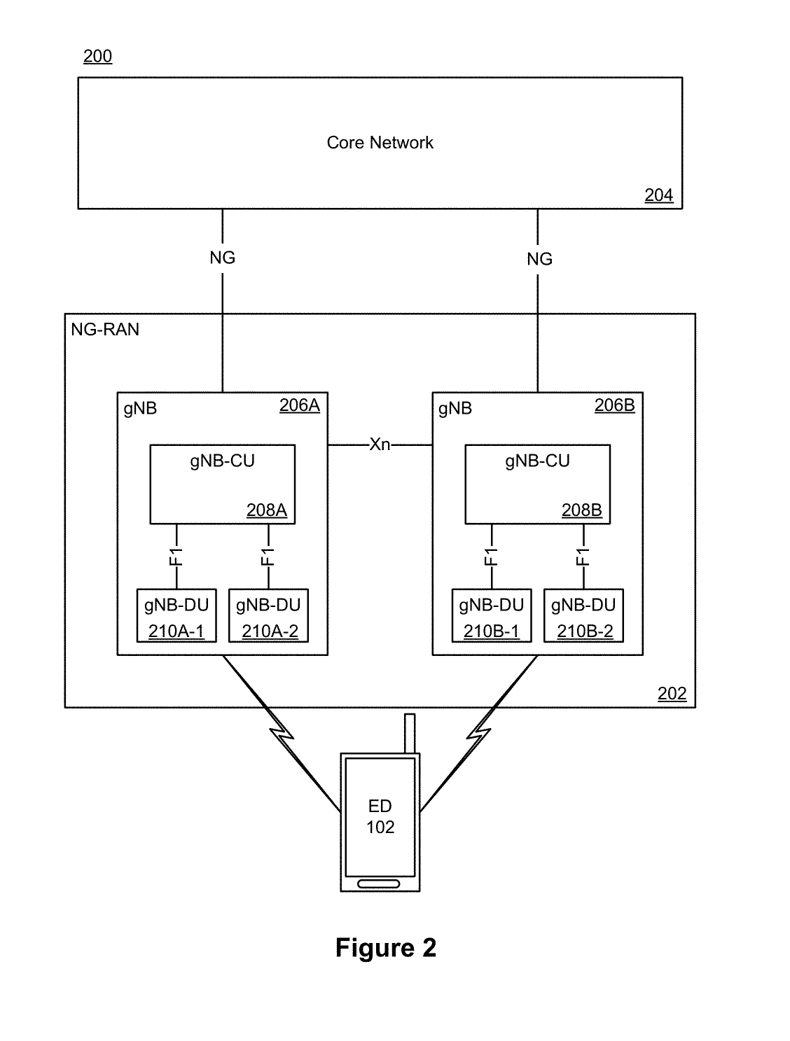

FIG. 2 illustrates a proposed architecture 200 for the implementation of a Next Generation Radio Access Network (NG-RAN) 202. NG-RAN 202 is the radio access network that connects an ED 102 to the core network 204. Those skilled in the art will appreciate that core network 204 may be the 5G Core Network. Nodes within NG-RAN 202 connect to the Core Network 204 over an NG bearer. This NG bearer can comprise both NG-C(N2) and NG-U (N3) interfaces. NG-RAN 202 includes a plurality of radio access nodes (referred to in an SA2 architecture either as a (radio) access node, or as a node within a (radio) access network). In 3G, the access node was referred to as a NodeB (NB), while in 4G it was referred to as an evolved Node B (eNodeB or eNB). In a NodeB, coordination with a Radio Node Controller (RNC) was employed to perform the radio resource and some of the mobility management functions for the Node B. With the development of the eNodeB, both scheduling and radio resource management were moved to the eNodeB. In the NG-RAN 202, a Next Generation Node B (gNodeB or gNB) 206A and 206B are able to communicate with each other over an Xn interface. Within a single gNB 206A, the functionality of the gNB is decomposed into a Centralized Unit (gNB-CU) 208A and a set of distributed units (gNB-DU 210A-1 and gNB-DU 210A-2, collectively referred to as 210A). gNB-CU 208A is connected to a gNB-DU 210A over an F1 interface. Similarly gNB 206B has a gNB-CU 208B connecting to a set of distributed units gNB-DU 210B-1 and gNB-DU 210B-2.

A RAN node is also connected to user equipment (UE—such as, for example Electronic Device) 102 via a radio link (Uu) and to other RAN nodes via an Xn interface that includes both a control plane component (Xn-C) and a user plane component (Xn-U).

A UE may establish multiple PDU sessions with the CN where different sessions may correspond to different instances of the NG-U user plane interface; each instance of the NG-U interface may terminate on a different CN user plane entity.

In an LTE system, similar interfaces exist: a RAN node is connected to a CN through an S1 interface and to other RAN nodes through an X2 interface.

The division of responsibilities between the gNB-CU and the gNB-DU has not been fully defined at this time. Different functions, such as the radio resource management functionality may be placed in one of the CU and the DU. As with all functional placements, there may be advantages and disadvantages to placement of a particular network function in one or the other location. It should also be understood that any or all of the functions discussed above with respect to the NG-RAN 202 may be virtualized within a network, and the network itself may be provided as a network slice of a larger resource pool, as will be discussed below.

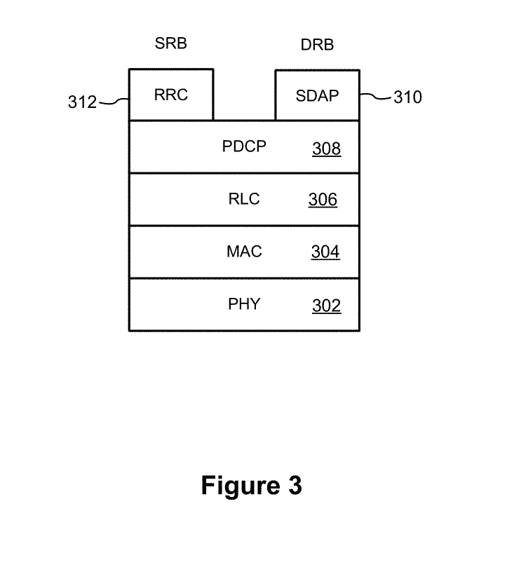

Referring to FIG. 3, the Uu interface between a UE 102 and a RAN node 206 may comprise several entities within the protocol stack. Example entities include:
physical layer (PHY) 302—which encodes information for transmission over the radio link.
medium access control (MAC) 304—which performs scheduling of radio resources according to traffic demands, multiplexing of MAC PDUs belonging to one or different logical channels onto PHY transport blocks, and error correction through Hybrid Automatic Repeat Requests (HARQ).
radio link control (RLC) 306—which performs segmentation and reassembly of RLC protocol data units (PDUs) for mapping onto PHY transport blocks, and provides error recovery through automatic repeat requests (ARQ).
packet data convergence protocol (PDCP) 308—which performs header compression and decompression for IP packets, in-sequence delivery of upper layer PDUs, PDCP PDU routing for transmission, duplicate packet detection, retransmission of lost PDCP PDUs, cryptographic integrity protection and encryption.
service data adaptation protocol (SDAP) 310—which performs routing of QoS flows onto the appropriate data radio bearer. A QoS flow may comprise an aggregation of user plane traffic receiving the same forwarding treatment (e.g. scheduling policy, queue management policy, rate shaping policy, RLC configuration, PDCP configuration). Providing different QoS forwarding treatment requires a different QoS flow.
radio resource control (RRC) 312 performs configuration of radio resources assigned to a UE, configuration of radio bearers for information exchange, management of radio link security associations, paging, measurement reporting, handover, and transport for non-access stratum signalling.

Control plane information such as RRC and Non-Access Stratum (NAS) signalling may be carried over a signalling radio bearer (SRB) while user plane data may be carried over a data radio bearer (DRB).

### Dual Connectivity (DC)

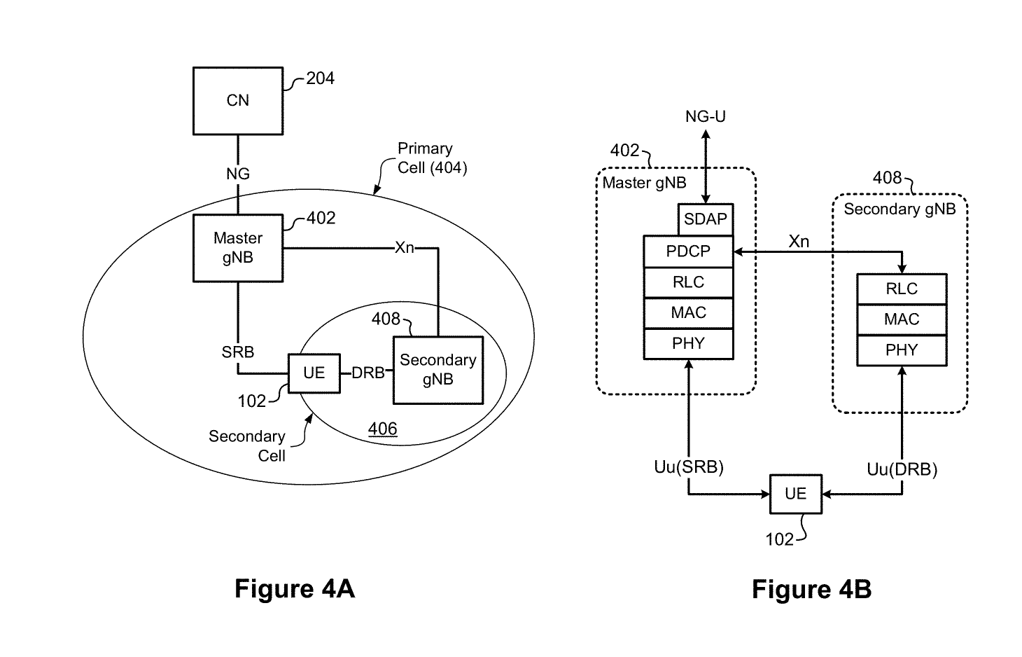

In some networks, a number of small cells may be deployed within the coverage area of a macro cell to offload traffic from the macro cell and/or to provide improved signal quality to UEs. FIG. 4A shows an example deployment in which a Master RAN node (MgNB) 402 provides the NG connections to the core network 204 and maintains a signalling radio bearer (SRB) to a UE 102 through a primary cell 404. The UE 102 may use a data radio bearer (DRB) to convey user plane traffic through a secondary cell 406 to a Secondary RAN node (SgNB) 408. This traffic may be relayed between the MgNB 402 and the SgNB 408 over an Xn interface.

On the network side, the user plane protocol stack in a dual connectivity deployment may be split between the Master RAN node 402 and the Secondary RAN node 408, as may be seen in FIG. 4B. The Master RAN node 402 provides the full protocol stack entities (including SDAP, PDCP, RLC, MAC and PHY) while the Secondary RAN node 408 provides the lower layer protocol stack entities (RLC, MAC and PHY).

Packet duplication (PD) can be used to satisfy high reliability requirements of both DRBs and SRBs. The network may make the decision for configuring packet duplication based on criteria which includes reliability requirements of the DRBs and SRBs. It has been observed that packet duplication may enhance resource utilization efficiency when certain conditions related to channel quality, PDU size and reliability requirement are satisfied. Considering the differences between SRBs and DRBs, the benefits of packet duplication may be realized by ensuring that the criteria and the triggering mechanism used for enabling packet duplication for SRBs is different from that of DRBs

Packet duplication is supported in both Dual Connectivity (DC) and Carrier Aggregation (CA) architectures. In the DC architecture, a split bearer (FIGS. 4A and 4B) may be configured. The split bearer may be used both with and without packet duplication. When packet duplication is deactivated, the configured bearer may be used as a split bearer with a defined splitting ratio. In the CA architecture, the UE may be configured with multiple component carriers, which can be used with packet duplication. When packet duplication is deactivated, the UE may use the normal CA operation.

The UE is configured for DC or CA by RRC in the RRC connection reconfiguration command. Similarly, packet duplication can also be configured by RRC in both architectures.

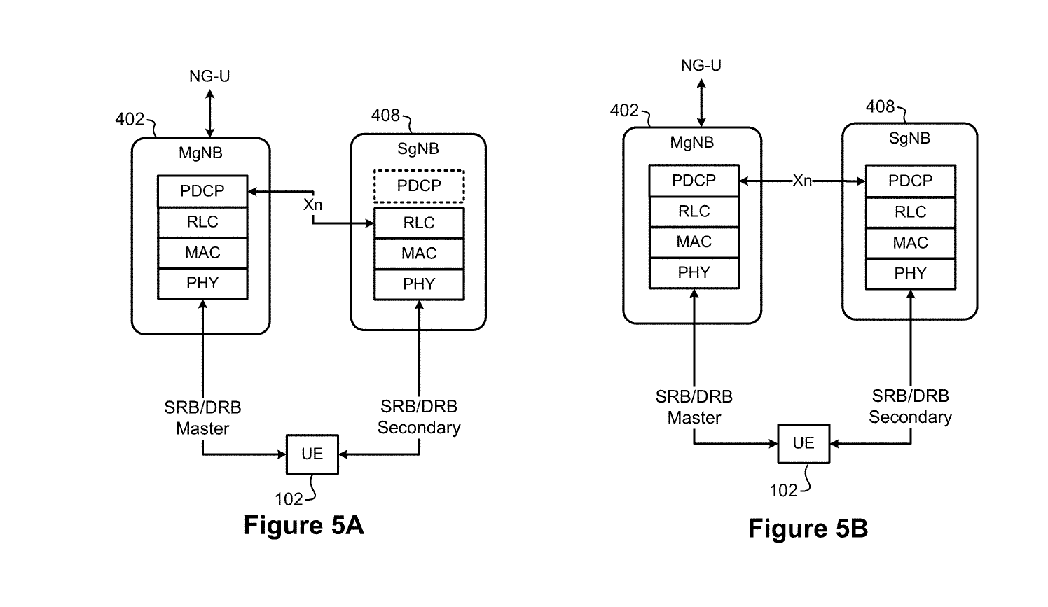

FIG. 5A illustrates a DC model of packet duplication that uses a split bearer architecture similar to that of FIG. 4B, in which a single PDCP entity (located in the MgNB 402) stores context information of the UE and so handles NG packet forwarding to and from the Core Network. The embodiment of FIG. 5A differs from that of FIG. 4B in that the PDCP entity may operate to duplicate both SRB and DRB PDUs destined for the UE 102, and forwards one copy directly to the UE 102 through its own RLC, MAC and PHY entities. The other copy is forwarded to the UE 102 via the Xn interface and the SgNB 408. FIG. 5B illustrates an alternative DC model in which both the Master and Secondary gNBs provide their own PDCP functionality.

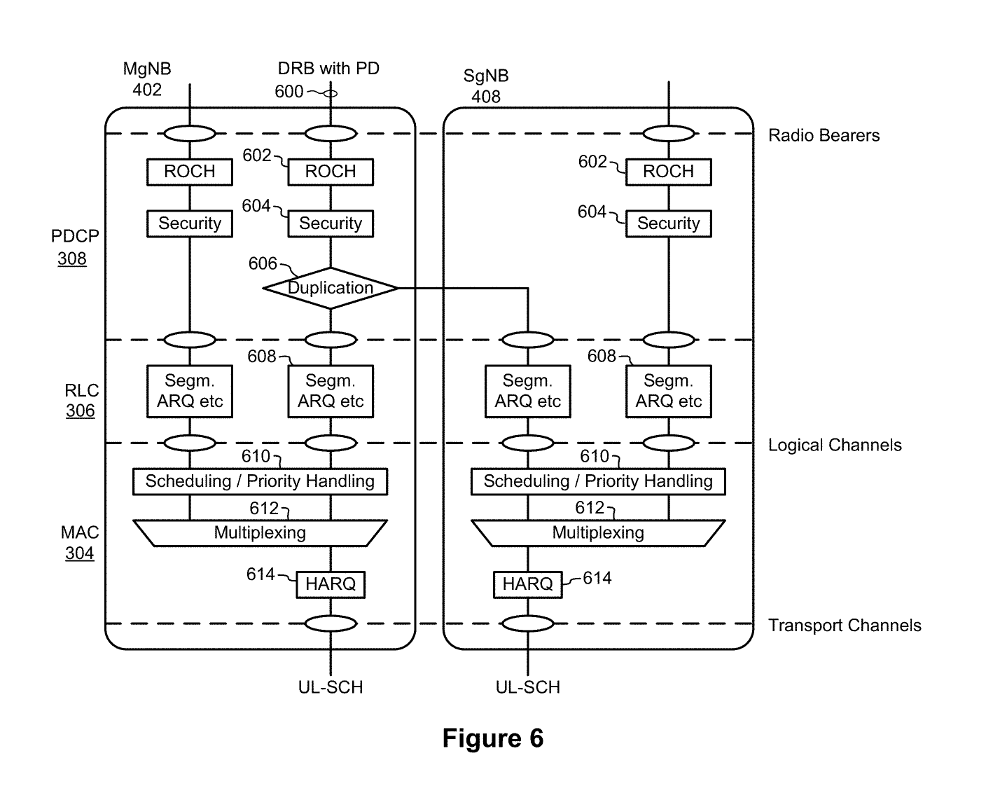

FIG. 6 illustrates an example layer 2 structure for UL in a DC architecture. In this example, one DRB (at 600) is configured for packet duplication. The packets that are sent on this DRB may be duplicated after the Robust Header Compression (RoHC) 602 and ciphering functions 604 are performed. The duplication decision is implemented in the PDCP 308, and may be based on information provided by the MAC entity 304, as will be described in greater detail below.

In the example of FIG. 6, the MgNB 402 and SgNB 408 comprise respective PDCP 308, RLC 306 and MAC 304. The PDCP 308 includes RoHC 602, security (ciphering) 604 and, optionally, packet duplication 606. The RLC 306 comprises, among other things, Segmentation and Automatic Repeat reQuest (ARQ) functions 608 known in the art. The MAC 304 includes Scheduling and Priority functions 610, multiplexing 612 and Hybrid Automatic Repeat reQuest (HARQ) 614, known in the art.

### Activation and Deactivation of Packet Duplication

In specific embodiments, the UE 102 may be configured (for example via RRC signalling) to control the activation and deactivation of packet duplication, based on Event Triggers received from the Master and Secondary gNBs. If desired, MAC Control Elements (CEs) may be used to convey the Event Triggers to the UE 102.

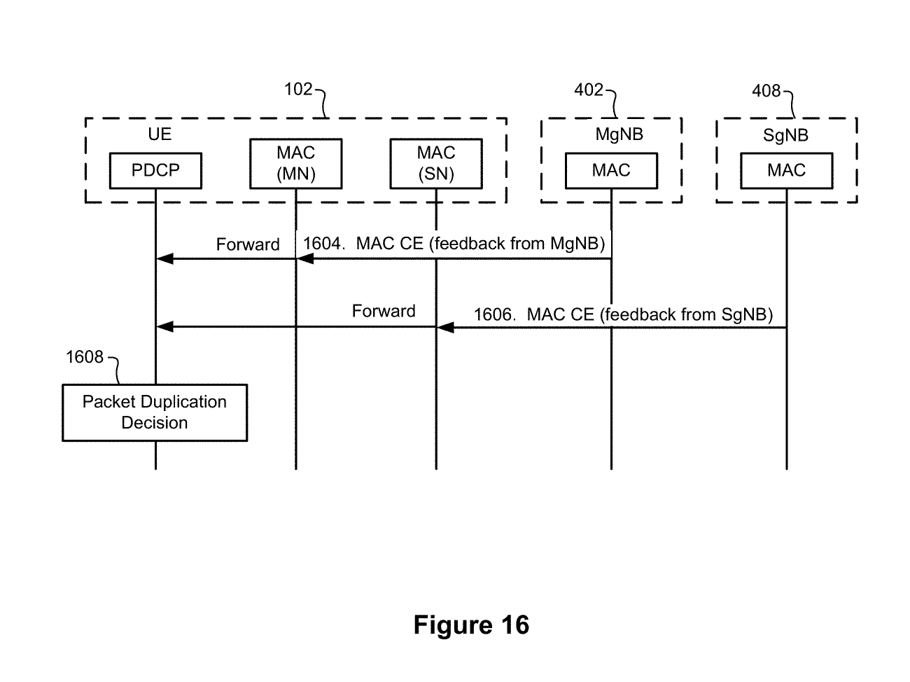

FIG. 16 is a message flow diagram illustrating a representative process for controlling packet duplication. In the example of FIG. 16, packet duplication is controlled by the UE 102 PDCP entity based on the content of MAC CEs received from the Master and Secondary gNBs.

### Event Triggers in MAC Control Elements

The MgNB 402 and SgNB 408 may independently measure the quality of their respective UL channel from the UE 102. The channel quality information may be defined in the form of an “event trigger”, which can be conveyed to the UE 102 in a DL MAC CE. The following procedure is an example of how the UE 102 can determine when to use packet duplication using the event triggers that are signalled in the DL MAC CEs.

In the DC architecture, the MgNB 402 and the SgNB 408 each measure the UE 102's UL channel and evaluate the channel measurement related criteria for packet duplication. For example, if the Channel Quality Information (CQI) measured by the MgNB 402, (CQI_MgNB) is less than a first predetermined threshold (Threshold1), then the corresponding Event trigger value may be set to EV1; if CQI_MgNB is greater than Threshold1 and less than a second predetermined threshold (Threshold2) then the corresponding Event trigger value may be set to EV2; and if CQI_MgNB is greater than Threshold2 then the corresponding Event trigger value may be set to EV3. Once the Event Trigger value has been selected, it can be forwarded (at 1604) to the UE 102 in a MAC CE. As may be appreciated, the SgNB 408 can also independently perform the measurement of Channel Quality Information (CQI) and compare the resulting CQI SgNB to Threshold1 and Threshold2 to derive corresponding Event Trigger values which can be forwarded (at 1606) to the UE 102 in a MAC CE.

The values of Threshold1 and Threshold2 can be chosen according to any suitable criteria. Additional event triggers can be configured as desired, for example to indicate loading constraints in the either or both of the Master and Secondary Nodes. Alternatively, the channel measurement information and or Trigger Event values can be adjusted to take into account loading in the respective node.

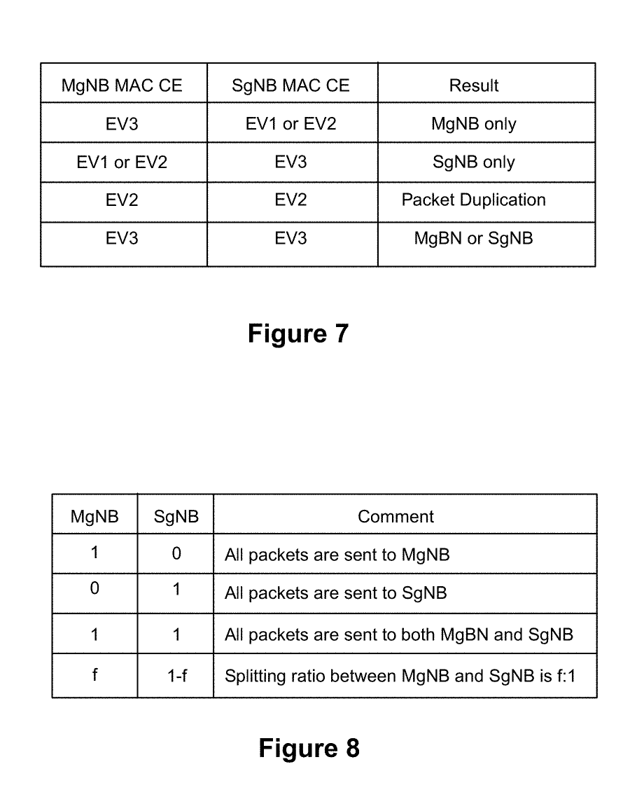

Upon receipt of the Event Trigger values from the MgNB 402 and SgNB 408, the UE 102 may determine (at 1608) whether or not packet duplication should be used for subsequent transmissions on a DRB that is configured with packet duplication. FIG. 7 is a table showing example rules for determining whether or not packet duplication is necessary. In the example of FIG. 7, the following rules are implemented:
If the respective Event Trigger values received from the MgNB 402 and SgNB 408 are EV3 and (either EV1 or EV2), then packets should be forwarded to the MgNB 402 only;
If the respective Event Trigger values received from the MgNB 402 and SgNB 408 are (either EV1 or EV2) and EV3, then packets should be forwarded to the SgNB 408 only;
If the respective Event Trigger values received from the MgNB 402 and SgNB 408 are both EV2, then packet duplication should be used; and
If the respective Event Trigger values received from the MgNB 402 and SgNB 408 are both EV3, then packets may be forwarded to either of the MgNB 402 and the SgNB 408.

As noted above, in a DC architecture, when packet duplication is deactivated, the UL channels to the MgNB 402 and SgBN may be used as a split bearer, and a splitting ratio can be defined to control the proportion of packets forwarded to each of the RAN nodes. FIG. 8 is a table showing an example, in which the UE 102 assigns a respective splitting flag value for each node. In the example of FIG. 8, a splitting flag value of 0 means that no packets may be forwarded to the associated node; a splitting flag value of 1 means that all packets may be forwarded to the associated node; while a splitting flag value of 0<f<1 defines the proportion of all packets that may be forwarded to each node. Thus, in the example of FIG. 8, the first two rows represent respective scenarios in which all of the packets are to be forwarded only to one of the MgNB 402 and SgNB 408, the third row corresponds with packet duplication, in which all packets are forwarded through both of the MgNB 402 and SgNB 408, and the fourth row defines a splitting ratio of f:1 between the MgNB 402 and SgNB 408.

As may be appreciated, the respective splitting flag values for each or the first three rows of FIG. 8 may be assigned directly from the Event Trigger evaluation rules described above with reference to FIG. 7. For the case of a splitting ratio of f:1 between the MgNB 402 and SgNB 408, the respective splitting flag values (f, 1−f) may be assigned based on the relative quality of the UL channels, which may, for example, be indicated by the respective Event Trigger values received from the MgNB 402 and SgNB 408.

In one embodiment, the splitting ratio can be a configured value, which can be configured by RRC. The splitting flag can be either set to 0 or 1 to dynamically activate/deactivate the fallback to the configured splitting ratio.

The UE 102 may also take additional information into account. For example, if the packet size of a particular packet is below a predetermined threshold then the UE 102 may deactivate packet duplication for that packet.

Using the above approach, the UE 102 can dynamically switch between packet duplication and link selection based on the information received from the MgNB 402 and SgNB 408.

It will be appreciated that the above approach can be readily extended to scenarios in which there are two or more Secondary RAN Nodes.

Buffer Status Report (BSR) with Packet Duplication

The UE 102 may calculate a respective Buffer Status Report (BSR) for each of the MgNB 402 and SgNB 408. For example, in scenarios in which either of packet duplication or split bearer modes of operation are selected, PDCP packets will be buffered for transmission to both of the MgNB 402 and SgNB 408. In this case, UE 102 PDCP entity may allocate respective amounts of buffer capacity to each of the MgNB 402 and SgNB 408. For example, the amount of buffer capacity allocated to the MgNB 402 may be PDCP_MgNB+RLC_MgNB (where PDCP_MgNB is an expected buffer requirement for PDCP signalling to the MgNB 402, and RLC_MgNB is an expected buffer requirement for RLC signalling to the MgNB 402). Similarly, the amount of buffer capacity allocated to the SgNB 408 may be PDCP_SgNB+RLC_SgNB. Note that in some embodiments both the PDCP_MgNB and PDCP_SgNB can be referring to the same expected PDCP packets in the buffer since the PDCP entity in the UE 102 is common to both MgNB 402 and SgNB 408 legs. In both of these cases, the expected buffer requirement for PDCP and RLC signalling may be determined based on the splitting flag values defining the proportion of packets being sent to each of the MgNB 402 and SgNB 408. Thus, for example, in a scenario in which PD is required, equal amounts of buffer capacity will be allocated to each of the MgNB 402 and SgNB 408. Otherwise, the total buffer capacity may be split between the MgNB 402 and SgNB 408 with a splitting ratio that may depend on the channel quality of both legs (as may be indicated by the splitting flag values). The BSR is performed per logical channel. For URLLC traffic, a separate logical channel can be used. In DC, if PD is activated then the packets in the PDCP are counted twice (i.e. for the MgNB 402 BSR and the SgNB 408 BSR). Otherwise, if PD is deactivated then the UE 102 falls back to the split bearer scenario and the BSR is calculated by applying the split ratio if the PDCP buffer size exceeds the splitting ratio threshold.

The UE 102 may calculate respective BSRs for each of the MgNB 402 and SgNB 408, using the amounts of buffer capacity allocated to each node, and use these BSRs to request UL grants from the MgNB 402 and SgNB 408.

### Management of Packets (Push or Pull)

In the “pull” based approach,
When the UE 102 receives the UL grant, the RLC “pulls” a packet from the PDCP layer. The packet is only duplicated if the RLC requests a PDCP PDU.

In the “push” based approach,
If duplication is required then the PDCP layer duplicates the PDCP PDU and sends (i.e. “pushes”) it to the RLC layer of both legs indicated by the event trigger.

The activation/deactivation procedure can be performed with either the “push” or “pull” based approach for buffer management.

### Packet Duplication for Robust Handover

Packet duplication can be used for robust handover of the MgNB 402. After receiving a handover command, the UE 102 may establish a radio connection to a target gNB (which then operates as the SgNB 408), while maintaining its radio connection to the MgNB 402 (which assumes the role of the source gNB). In this make-before-break approach, the UE 102 will retain one PDCP entity, but a separate PHY, MAC and RLC entities for each of the source and target gNBs.

Make Before Break Handover with Packet Duplication

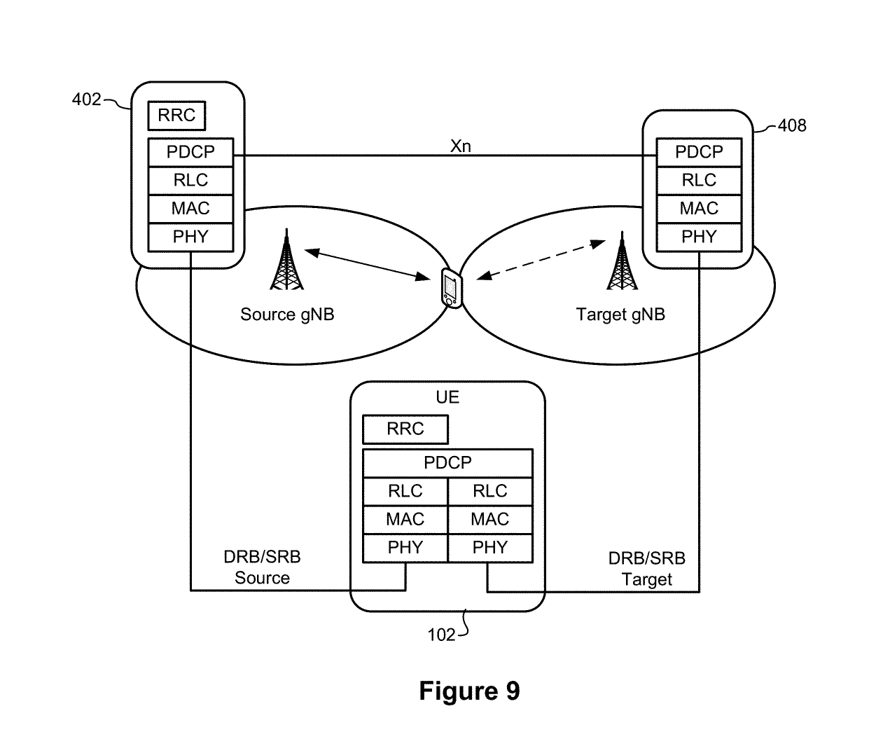

FIG. 9 illustrates make before break handover with packet duplication. As may be seen in FIG. 9, the source and target gNBs each have a full protocol stack. The UE 102 establishes a radio connection with the target gNB 408 without releasing the connection to the source gNB 402. In order to support the two connections, the UE 102 maintains a single PDCP entity, but separate PHY, MAC and RLC entities for communication with each of the source and target gNBs.

The common PDCP contains respective ciphering keys associated with the source and target gNB. For UL transmission during handover, the UE 102 transmits duplicate PDCP SDU packets to the source and target gNBs using the corresponding ciphering keys.

In the network, each gNB deciphers UL packets using its own ciphering keys. The target gNB forwards the received PDCP SDU packets to the source gNB (via the Xn interface) when the source is the anchor node. After the path switch, the target gNB becomes the anchor, and the source gNB will forwards its packets via the Xn interface to the target gNB.

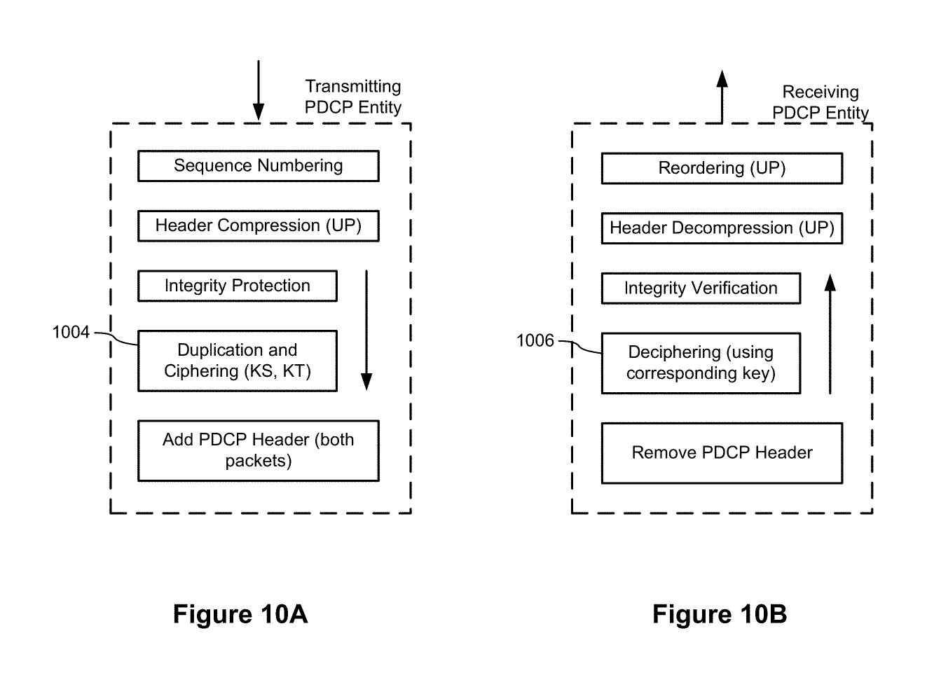

Functions performed in the transmitting and receiving PDCP entities in the UE 102 are illustrated in FIGS. 10A and 10B, respectively.

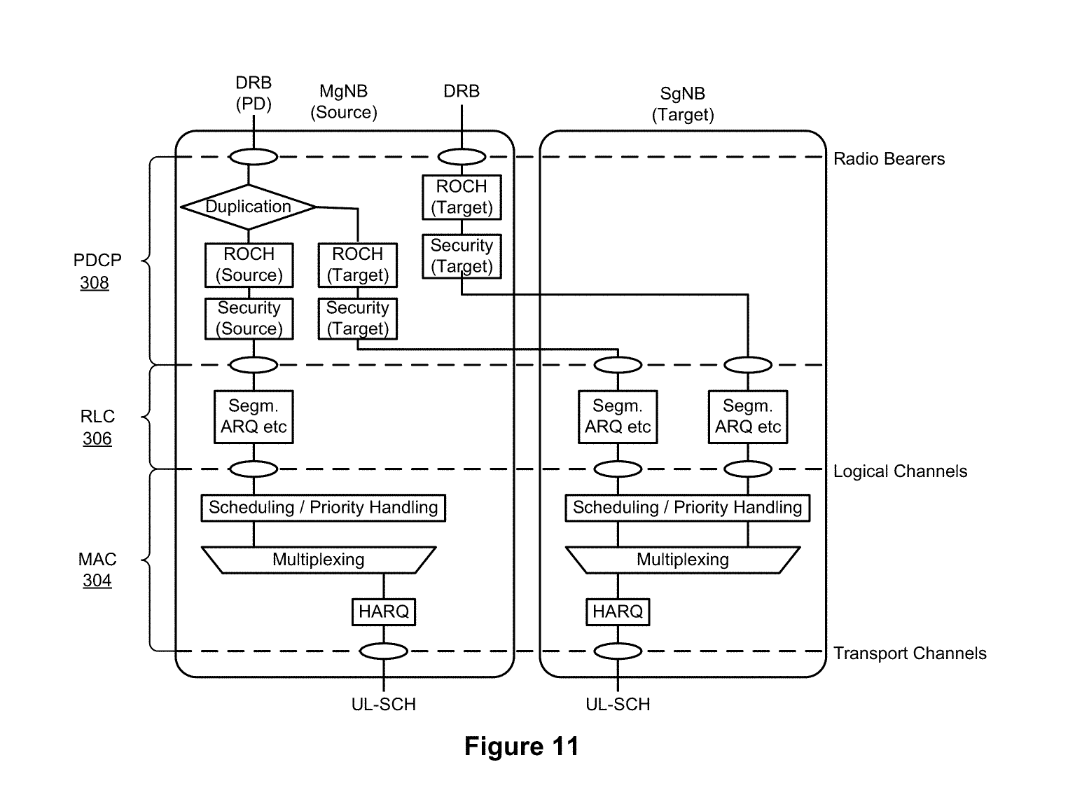

The transmitting PDCP entity can be modified to support packet duplication to the source and target gNBs by adding a duplication function 1004 with separate ciphering keys for the duplicate packets. The receiving PDCP entity can be modified by adding a deciphering function 1006 to decipher lower layer packets with the appropriate keys. The layer 2 structure for UL with DC configured for packet duplication during the handover of the MgNB 402 is illustrated in FIG. 11.

The UE 102 has one PDCP entity, but separate PHY, MAC and RLC for the source and target gNBs. For DRBs that require packet duplication, the UE 102 uses the keys associated with the source gNB when sending packets to the source gNB and uses the keys associated with the target gNB when sending duplicated packets to the target gNB. New packets that do not require packet duplication can be sent to the target gNB on the DRB configured without packet duplication.

If the link to the source gNB degrades below a specified threshold, the link to the source gNB can be released and the RRC can be relocated to the target gNB.

### Non-Ideal Backhaul

In some scenarios, the latency on the Xn interface may exceed the latency requirements for the service. When the latency on the Xn interface exceeds the latency requirements, the core network can perform packet duplication during the make-before-break handover procedure, and forward duplicated DL packets directly to each of the source and target gNBs. In this case, a PDU session should be established with two separate tunnels (i.e. one tunnel to the MgNB 402 and the other tunnel to the SgNB 408).

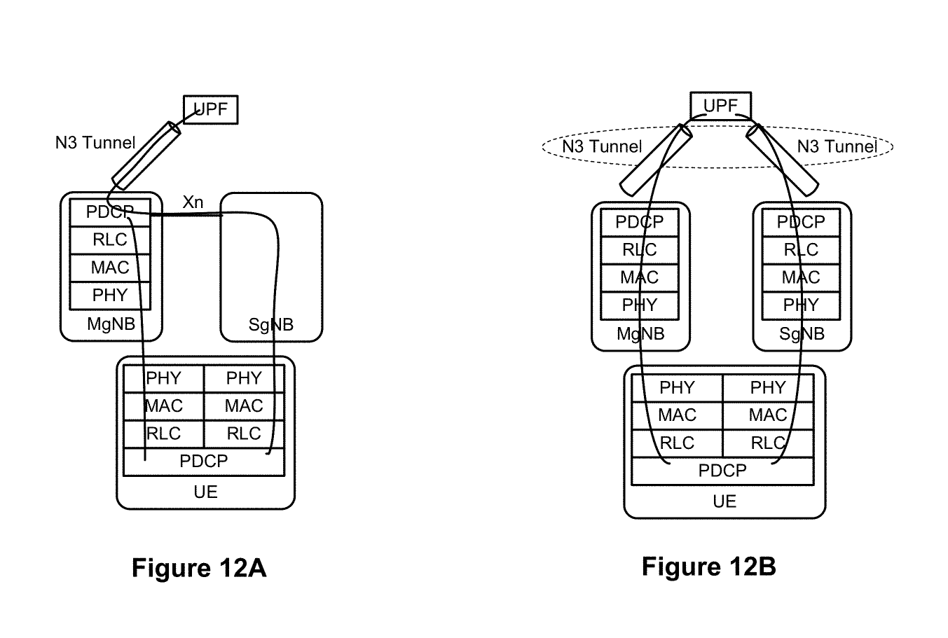

The make-before-break handover with DL packet duplication in the MgNB 402 is illustrated in FIG. 12A. In this scenario, the PDCP in the MgNB 402 is responsible for duplicating DL packets and removing duplicate UL packets before delivery to the core network. The PDCP in the UE 102 is responsible for duplicating UL packets and removing duplicate DL packets.

The make-before-break handover procedure with packet duplication in the core network is illustrated in FIG. 12B. In this case, a packet duplication and removal function is required in the UPF and in the PDCP entity in the UE 102.

Once the packet duplication is activated in the UPF, a PDCP reestablishment procedure can be initiated to ensure that the PDCP sequence numbers are the same for the same DL packets transmitted by the source (MgNB 402) and the target (SgNB 408). For UL packets, the UE 102 can use the same PDCP sequence number for both legs, but since there are two separate receiving PDCP entities, the sequence numbers must be provided to the UPF to identify the duplicate packets for removal.

In another embodiment, a new sequence number can be introduced before the packet is duplicated in the UE 102 and in the UPF. The sequence number can be used to identify the duplicate packets for removal.

In another embodiment, the sequence numbering function performed by the PDCP function can be moved to the UPF. The remaining PDCP functions can be located in the source and target nodes.

DC Based Handover with Packet Duplication

In the existing DC architecture option 3C, there is only one PDCP entity in the network. In this case, the UE 102 only has one security association with the common PDCP. The UE 102 uses the same set of keys for communication with both the master and the secondary gNB. The DC architecture option 3C is illustrated in FIG. 5A. If the UE 102 is configured for packet duplication, the PDCP entity is responsible for duplicating/removing PDCP PDUs.

During a handover of the anchor node, the PDCP entity must be relocated from the source gNB to the target gNB. However, if packet duplication is required for reliability during the handover then the UE 102 should send UL packets to both the source and target gNBs using the keys from the source gNB before the PDCP is relocated to the target gNB. After the PDCP is relocated to the target gNB, the UE 102 begins to use packet duplication with the keys for the target gNB.

The key difference between the DC based handover with packet duplication and the make-before-break handover with packet duplication is that in the DC based handover with packet duplication, the PDCP entity in the anchor/master is responsible for packet duplication/removal of PDCP PDUs. Otherwise, in the make-before-break based handover with packet duplication, the anchor PDCP is responsible for packet duplication/removal of the PDCP SDUs.

### Packet Duplication in CA Architecture

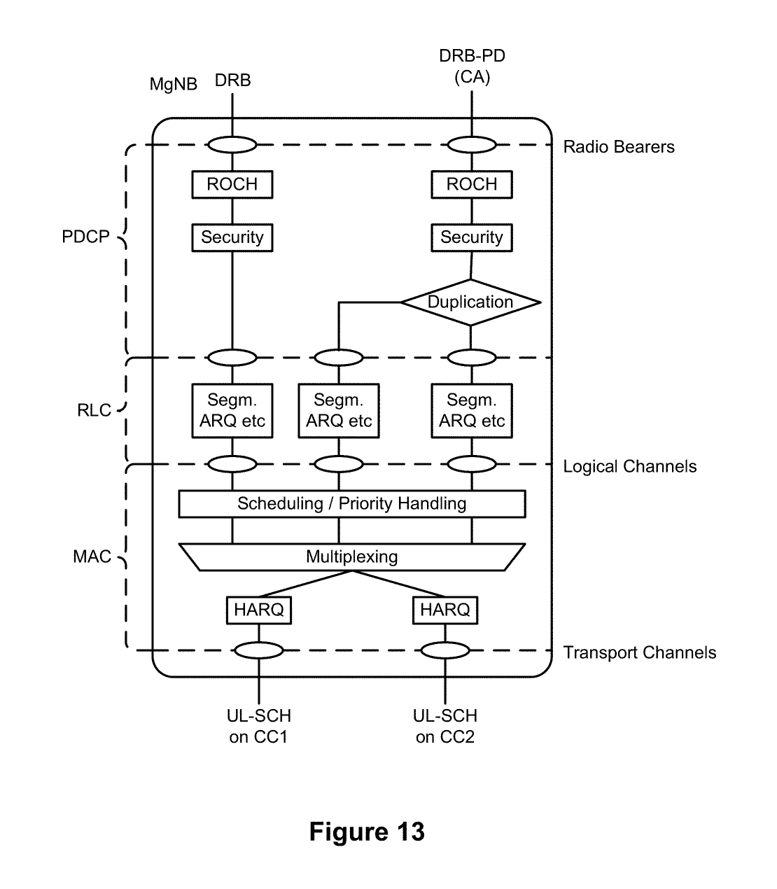

FIG. 13 illustrates Packet duplication implemented in a CA architecture. In such a case, the UE 102 can be configured with a DRB for packet duplication on different carriers. The UE 102 may also have other DRBs that are not configured for packet duplication. The duplicated packets may be mapped to different logical channels in RLC, and the RLC logical channels may be mapped to different carriers. If desired, packets associated with a non-duplicated DRB can be multiplexed into the same TB as one of the duplicated packets.

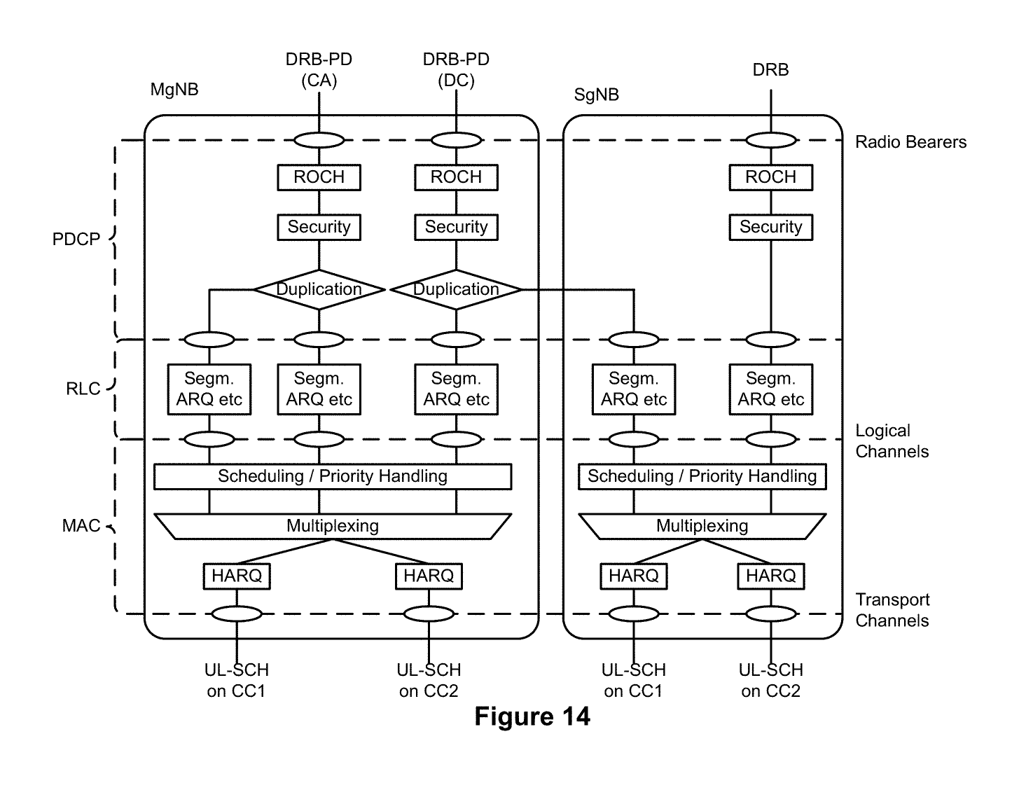

FIG. 14 illustrates a further alternative embodiment, in which the UE 102 is configured with one DRB for packet duplication in CA, and another DRB for packet duplication in DC. In this case, the UE 102 should decide which DRB to use.

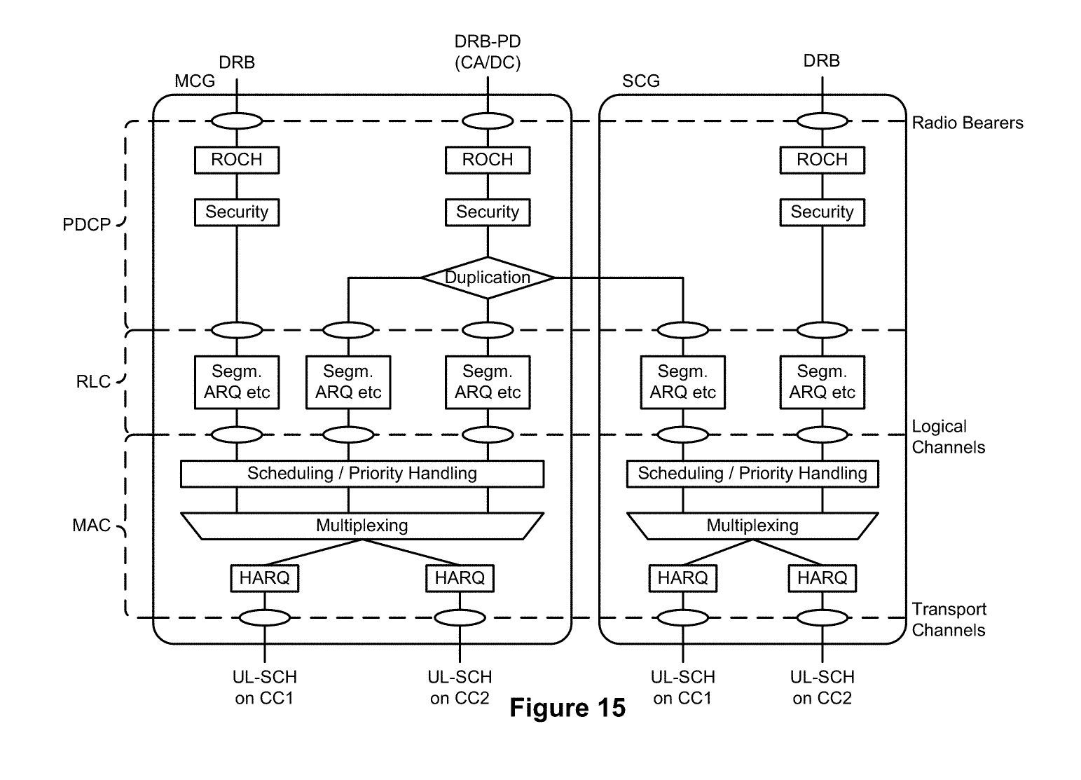

FIG. 15 illustrates a further alternative embodiment, in which the UE 102 can be configured with a DRB for packet duplication that can be across different carriers or different cells. The decision is made by the UE 102 dynamically.

### Packet Duplication for SRBs

In the case of SRBs, packet duplication can be used for achieving robustness and RRC diversity. The RRC messages are transmitted over more than one link to the terminating RRC entity in the network (in UL) or UE 102 (in DL). In comparison to DRBs, SRBs are characterized by less frequent transmissions, small PDU sizes and higher scheduling priority. As such, the packet duplication criteria for SRBs may be different than for the DRBs. In certain scenarios (e.g. cell centre with LOS conditions), it may be possible to satisfy the reliability requirement for SRBs by transmitting only over the single best link as in the case of using link selection. However, in cell edge scenarios, it may be necessary to perform packet duplication on the SRBs and transmit the SRBs using two links.

The network configures the UE 102 for packet duplication of SRBs using RRC signalling. The decision for configuring packet duplication can be made based on the criteria which include reliability requirements of the SRBs, channel quality measurements, loading conditions and expected SRB PDU sizes.

For UL transmission, packet duplication for SRBs can be configured for both CA and DC architectures. While in the CA case the duplicated SRBs can be transmitted by the UE 102 using two component carriers (i.e. either MgNB 402 or SgNB 408), in DC the transmissions are performed using both the MgNB 402 and SgNB 408 links, similar to case of using split SRB.

In the EN-DC architecture, the MgNB 402 and SgNB 408 use different PDCP (i.e. MgNB 402 uses LTE PDCP and SgNB 408 uses NR PDCP). In light of the existing RAN2 agreements, packet duplication can only be configured for the SRBs intended for SgNB 408 (i.e. SCG SRBs) supporting the NR PDCP. Since the MgNB 402 supports only LTE PDCP in EN-DC, packet duplication is not configurable for MCG SRBs.

The criteria for packet duplication of SRBs in both DL and UL can be determined by the network based on the type of the SRB. This is because different types of SRBs, which contain different CP messages, have different priority. For example, SRB1 (e.g. RRCConnectionReconfiguration messages, configured measurement reports) has a higher priority than SRB2 (e.g. NAS messages).

For the case of NR-NR DC architecture, both SRB1 and SRB2 can be configured for packet duplication. The CA architecture should also be considered for packet duplication of SRBs. Specifically, the scenarios considered for packet duplication for MCG SRB (i.e. SRB1 and SRB2) are listed as follows:
CA in NR-NR: RRC packets on SRB1/SRB2 are sent via PCell and SCell links to NR PDCP in MgNB 402
DC in NR-NR: RRC packets on SRB1/SRB2 are sent via MgNB 402 and SgNB 408 links to NR PDCP in MgNB 402

Packet duplication can also be used for satisfying the reliability requirement for SCG SRBs (i.e. SRB3) terminating at the SgNB 408. The SRB3, which carry measurement reports and RRCConnectionReconfiguration messages, are established between the UE 102 and SgNB 408 in order to minimize the latency associated with forwarding the RRC containers over the Xn between the MgNB 402 and SgNB 408. For SRB3, packets can be transmitted directly by the UE 102 to the SgNB 408 without coordination from the MgNB 402. However, higher robustness and RRC diversity can be achieved with packet duplication in both CA and DC architectures. In this case, the scenarios considered for packet duplication for SRB3 are listed as follows:
CA in EN-DC: RRC packets on SRB3 are sent via PSCell and SCell links to NR PDCP in SgNB 408
CA in NR-NR: RRC packets on SRB3 are sent via PSCell and SCell links to NR PDCP in SgNB 408
DC in EN-DC: RRC packets on SRB3 are sent via MgNB 402 and SgNB 408 links to NR PDCP in SgNB 408
DC in NR-NR: RRC packets on SRB3 are sent via MgNB 402 and SgNB 408 links to NR PDCP in SgNB 408

Since RRC is used to configure packet duplication, it can also be used to activate/deactivate packet duplication. A separate RRC command can be used to activate/deactivate packet duplication for an SRB.

If an SRB is configured for packet duplication, individual RRC message requests may include an RRC activation/deactivation command to specify whether packet duplication is required for the RRC response. For example, if the gNB sends an RRC request for neighbour cell measurements, the request can include the packet duplication activation/deactivation command, rather than sending a separate RRC command for activation/deactivation. After receiving the command, the UE 102 will respond using packet duplication on the SRB only if requested.

The decision to activate packet duplication may depend on the destination node for the RRC message. For example, if a measurement report request is sent from the MgNB 402, the response from the UE 102 to the MgNB 402 should be sent on the same SRB as the request message. However, if the channel condition to the MgNB 402 node is below a threshold then packet duplication may be necessary to ensure the reliability of the RRC message even if the DL request was only sent on a single link from the MgNB 402. In contrast, if a measurement report is requested by the SgNB 408 then the response should be sent to the SgNB 408 on the same SRB as the request. Since the channel condition to the SgNB 408 may be higher than that of the MgNB 402, packet duplication may not be necessary for the response message.

Since the network is aware of the each SRB message requested from the UE 102 and provides the necessary resource configuration for UL transmissions, dynamic activation/deactivation of packet duplication is not required for SRBs. The PDCP entity in the UE 102 performs the duplication as configured and utilizes the resource grants provided by the network to transmit the duplicate SRBs over the configured links.

As noted above, when Packet Duplication (PD) is deactivated, the UE 102 may fall back (or revert) to a split bearer mode of operation. Alternatively, the UE 102 may fall back (revert) to a single bearer, which may be referred to as a fallback (FB) leg. The FB leg may be supported by either the MgNB 402 or the SgNB 408, or by an access node other than the MgNB 402 or SgNB 408.

### Dynamic Control of Packet Duplication

There are two options for supporting dynamic control of packet duplication.

In option 1, it is assumed that the node that is hosting the PDCP entity sends the MAC CE and that the packet duplication command is a coordinated decision taking into account the channel conditions at both nodes.

In contrast, in option 2, it is assumed that there is no coordination between MgNB 402 and SgNB 408 and each node independently indicates the packet duplication command in a separate MAC CE. In this case, the UE 102 determines how to make use of the information in the MAC CEs.

### Option 1: Coordinated Packet Duplication Command

In this option, it is assumed that the packet duplication decision is made in the PDCP entity in the network. The MAC CE contains a bitmap that indicates if the corresponding DRB is activated for packet duplication. In this option, there are no conflicts for the UE 102 to resolve. However, there is an increase in delay due to the interaction between the MgNB 402 and SgNB 408, which may be dependent on the specific implementation.

Since the activation/deactivation of packet duplication is controlled dynamically, the fall back to the best link when the packet duplication is deactivated should preferably also be dynamically controlled. The initial fallback leg can be configured in RRC, but the subsequent link selection commands can be enabled using MAC CEs.

For example, if the UE 102 receives a deactivate command and the node configured to support the fallback for packet duplication is not the best link then the UE 102 will not satisfy the reliability requirement. In this case, a link selection bit should be included with the packet duplication command.

To indicate the best link for the UE 102 to use when packet duplication is deactivated, a bit in the MAC CE sub-header can be used to identify the best link for the DC based DRBs that are configured with packet duplication. The option provides link selection support for DC only. It is assumed that for CA, the normal CA operation is used when packet duplication is deactivated. In this option, the UE 102 should only receive one coordinated packet duplication MAC CE from the node hosting the PDCP.

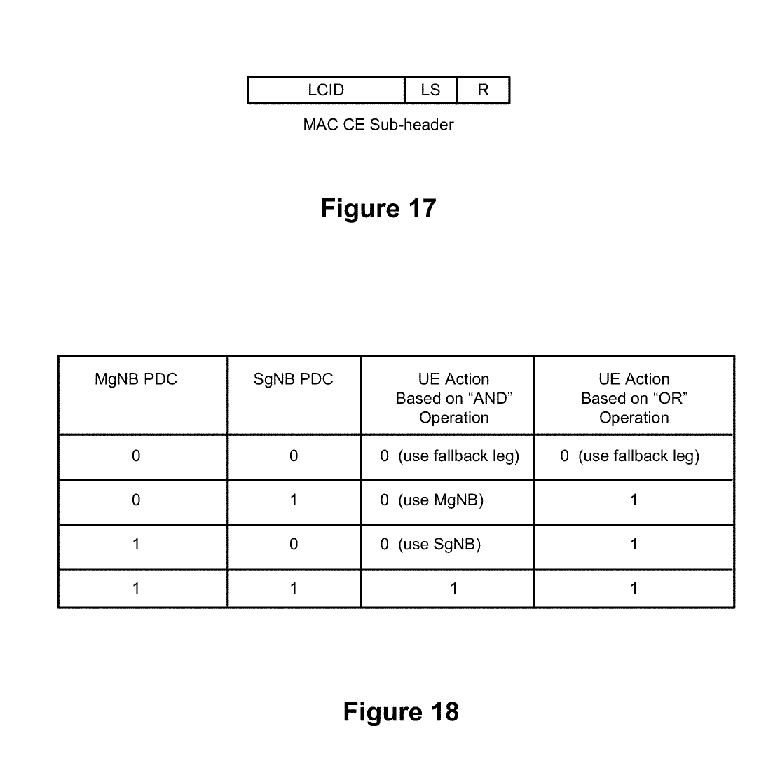

A representative packet duplication MAC CE sub-header for this case is illustrated in FIG. 17.

### Option 2: Uncoordinated Packet Duplication Commands

In the uncoordinated case, for the DC architecture, it is assumed that the MgNB 402 and SgNB 408 send the MAC CE packet duplication command individually. The UE 102 may be configured to determine how to make use of the individual packet duplication commands.

Preferably, the dynamic control of packet duplication should allow for various implementations, such as the following:
UE 102 performs “AND” operation between MgNB 402 and SgNB 408 commands,
UE 102 performs “OR” operation between MgNB 402 and SgNB 408 commands and
UE 102 follows the last received packet duplication MAC CE

If the UE 102 performs the “AND” operation, the UE 102 should keep track of the packet duplication command from each node. For example, if the UE 102 receives an activate command from the MgNB 402 and receives a deactivate command from the SgNB 408, the UE 102 can assume that the SgNB 408 link can satisfy the reliability without assistance from MgNB 402. In this case, links selection can be supported without any changes to the MAC CE. If the UE 102 receives a deactivate command from both MgNB 402 and SgNB 408 then the UE 102 can fall back to the configured splitting ratio. If the UE 102 receives an activate command from both MgNB 402 and SgNB 408, the UE 102 activates packet duplication.

In an alternate implementation, the UE 102 can perform the “OR” operation. This case can satisfy the reliability requirement, but it may result in a waste of resources and UE 102 power consumption since the UE 102 performs PD even when a single link is sufficient. These two different UE 102 implementations, for selected combinations of the splitting flag values described above with reference to FIG. 8, are illustrated in the table shown in FIG. 18.

However, in another UE 102 implementation the UE 102 may always follow the last received packet duplication command. In this implementation, the UE 102 may not satisfy the reliability requirement. For example, if the MgNB 402 sends an activate command and the SgNB 408 sends a deactivate command then the UE 102 will deactivate packet duplication and will use the configured fallback leg for transmission. However, if the configured link is the MgNB 402 then the UE 102 cannot satisfy the reliability requirement.

This implementation also results in a waste of resources and UE 102 power consumption since the UE 102 will perform packet duplication even when it is not necessary. For example, if the UE 102 receives a deactivate command from the MgNB 402 followed by an activate command from SgNB 408, the UE 102 will activate packet duplication even though the link to the MgNB 402 can satisfy the reliability requirement.

In order to satisfy the reliability requirement with this UE 102 implementation, a separate MAC CE is required to indicate the best link to be used when packet duplication is deactivated. This coordinated link selection MAC CE should be sent from the node hosting the PDCP entity. Since this is only required for the DC architecture, a single bit can be used to indicate which link is the best link. This link selection bit can be included in a MAC CE sub-header.

### Allowing Both Coordinated and Uncoordinated Implementations

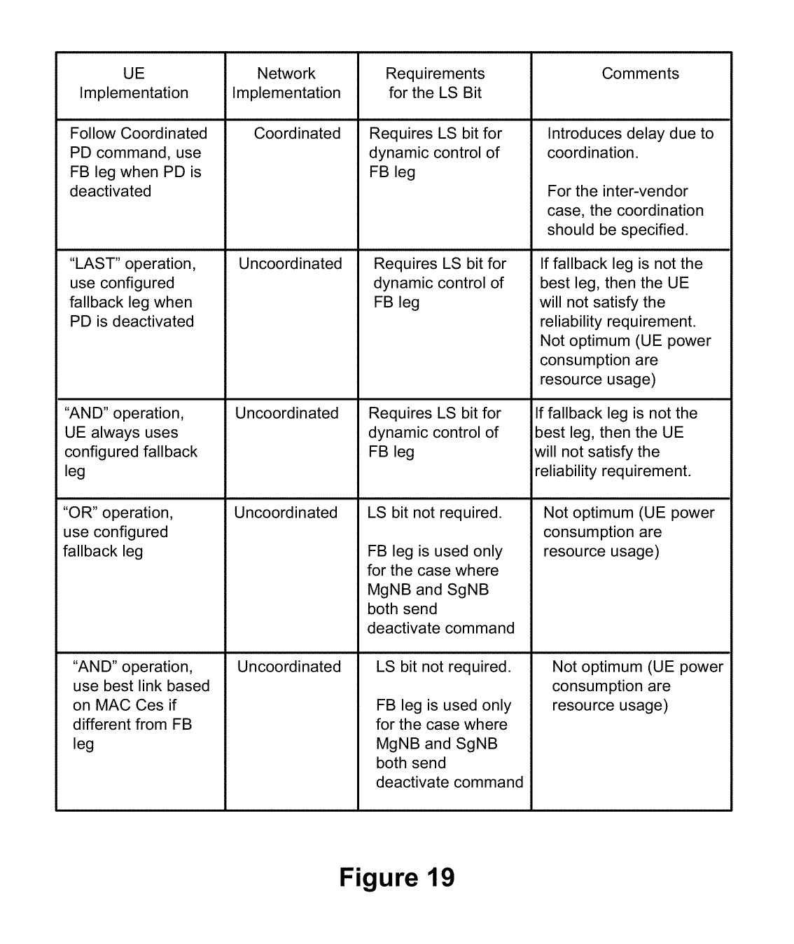

The dynamic control of packet duplication should allow for different network and UE 102 implementation options. The table shown in FIG. 19 illustrates the requirements for link selection for the different UE 102 and network implementation options.

In the EN-DC case, there will only be one MAC CE for packet duplication sent from the node that is hosting the NR PDCP. In this case, the UE 102 can always apply the command that it receives.

In order to satisfy all of the possible implementations for both coordinated and uncoordinated packet duplication MAC CEs, the packet duplication MAC CE sub-header can include a link selection flag (LSF) and a link selection bit (LS).

If the LSF is set to “1” then the UE 102 uses the fallback link indicated by the link selection bit. This can be used for the coordinated packet duplication MAC CEs. Otherwise, for the uncoordinated case, the LSF can be set to “0” to indicate that the UE 102 can select the best link using the information provided in the MAC CEs.

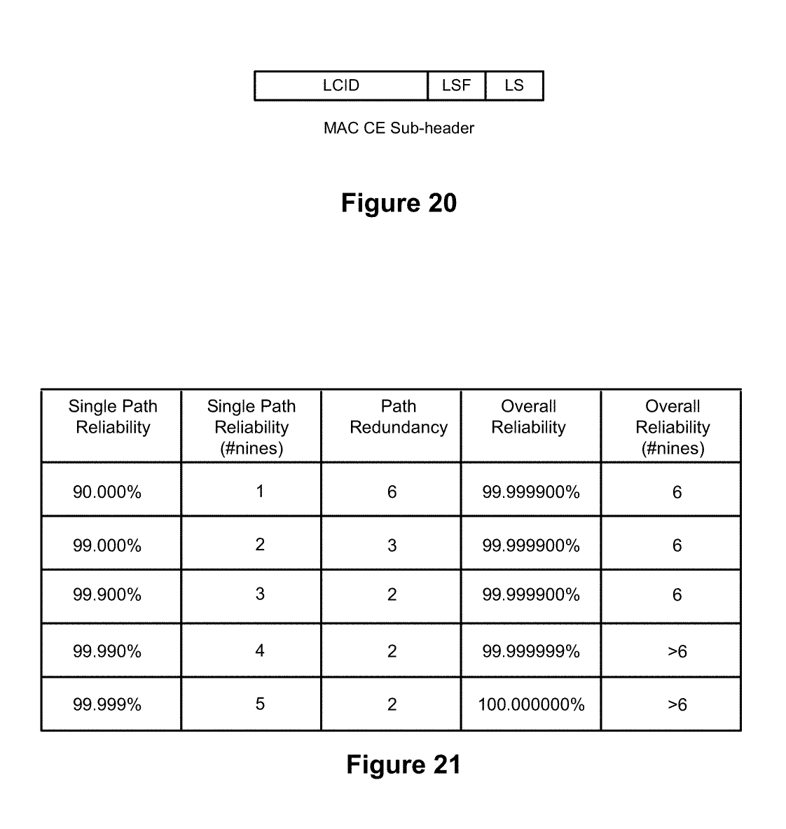

In this case, the MAC CE sub-header may have the format illustrated in FIG. 20.

The UE 102 can provide information about the method it uses for combining the MAC CEs to the network, for example during the UE 102 capability exchange procedure when the UE 102 attaches to the network. In one embodiment, the UE 102 can either indicate to the network if it is capable of combining the duplication MAC CEs or if it can only follow each duplication MAC CE command. In another embodiment, the UE 102 can also indicate the method of combining the independent MAC CEs for example, whether the “AND” or “OR” approach is used).

The method for dynamic control of UL packet duplication can also be used for DL packet duplication. In this case, the UE 102 may send an UL packet duplication MAC CE to indicate that it requires DL packet duplication, in order to satisfy the reliability requirements, for example. The UE 102 may send a single MAC CE to the node that hosts the PDCP or it may send a MAC CE to both of the nodes, which are subsequently both forwarded to the PDCP. The network node hosting the PDCP may then activate the DL packet duplication based on the received UL duplication MAC CEs.

### Redundant Transmission in DC Architecture 1A

URLLC can be satisfied using packet duplication in DC architecture option 3C. However, this option may not always be the best deployment option due to the latency over Xn. Architecture option 1A can reduce the E2E transmission delay when the AS is not collocated with the UPF at an edge node and when the UPF is not collocated with the RAN node(s).

### Redundancy

Redundancy can be used to improve the reliability in the RAN and the CN without impacting the latency.

The impact of redundancy on the reliability is illustrated in the table of FIG. 21.

For example, if the reliability in the RAN using a single link is 99.999% (5 nines) then a reliability of 99.9999% (6 nines) can be achieved by using 2 redundant paths/links (i.e. packet duplication).

Similarly, the reliability in the CN can also be increased using redundant paths. If the target CN reliability is 6 nines and the single path reliability is between 3 nines and 5 nines then two redundant paths are required to satisfy the target reliability.

### Packet Duplication Using DC Architecture

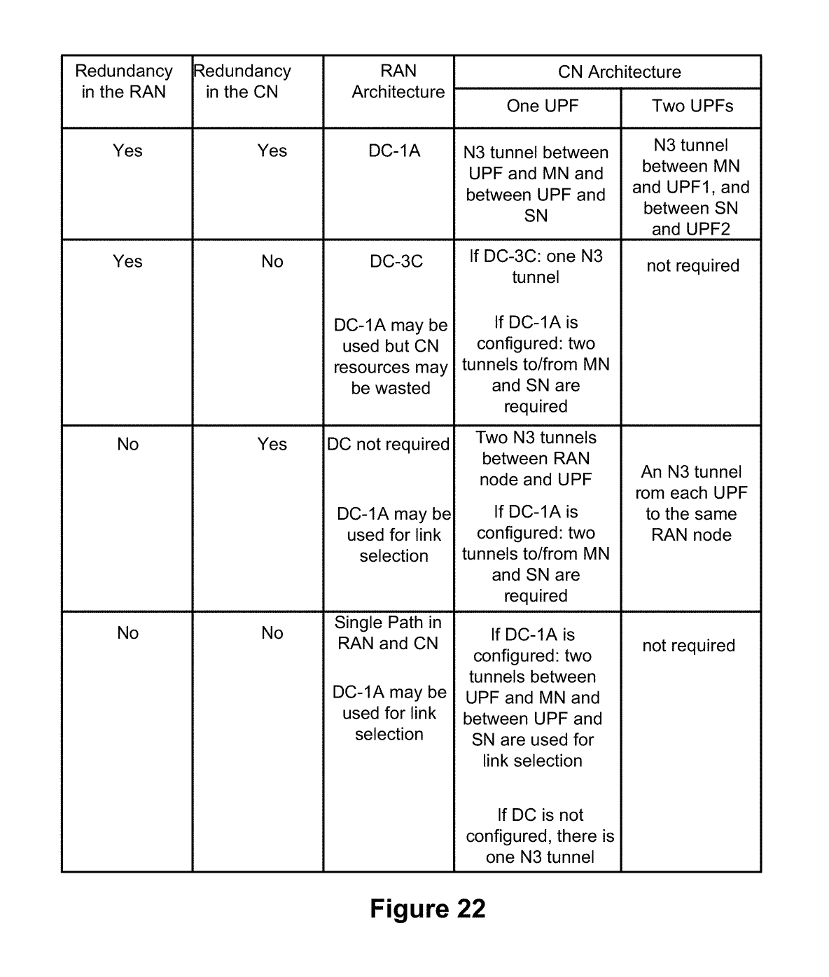

There are 4 cases to consider in order to satisfy the E2E requirements for URLLC. The options are based on whether redundancy is required in the RAN and/or the CN. For example, redundancy may be required in both the RAN and the CN, only in the RAN, only in the CN or not required in either the RAN or the CN. These options are summarized in the table of FIG. 22.

### DC Architecture Option 3C

In the DC architecture option 3C, DL and UL packet duplication can be used to provide high reliability with ultra-low latency.

In both CA and DC(3C), there is only one PDCP entity in the UE 102 and one in the RAN. The packets are duplicated in the transmitting PDCP entity. Duplicates packets are removed in the receiving PDCP entity.

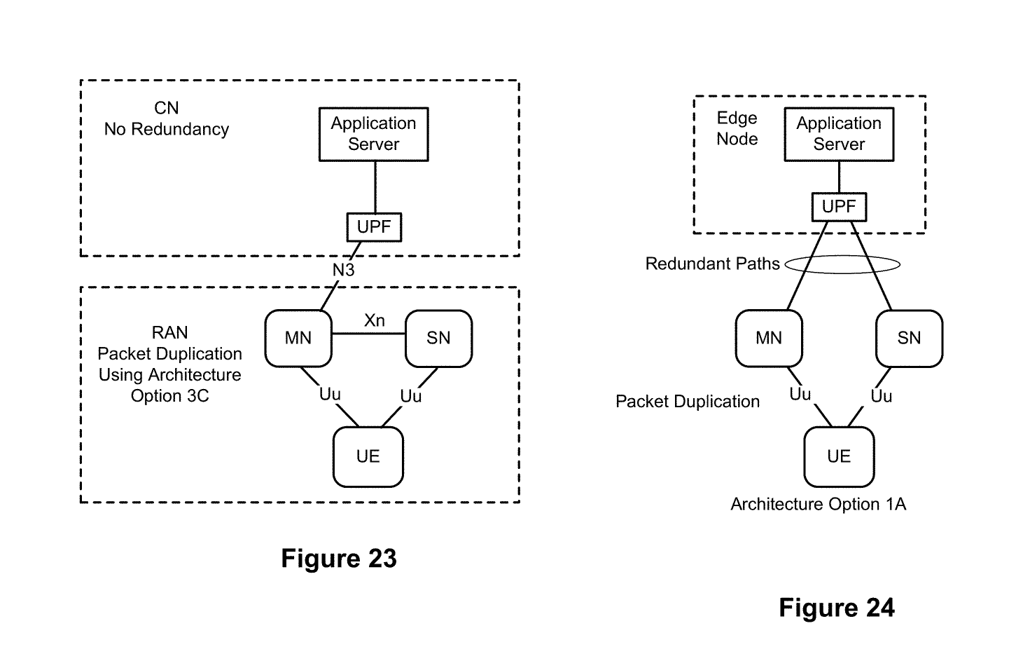

A representative RAN solution for providing redundancy is illustrated in FIG. 23Error! Reference source not found.

The RAN solution may be sufficient in some cases, such as when the AS is collocated with the RAN node. However, if the AS is located further in the core network then the reliability of the CN will impact the E2E reliability. If a single path in the CN cannot meet the required reliability target then redundant paths are necessary. A highly reliable tunneling protocol is required in the CN that allows for redundant parallel transmissions on different paths.

In order to provide redundancy in the CN and to further improve the reliability, there are two RAN architecture options for dual connectivity (DC) to consider.

In DC architecture option 3C, the UE 102 is connected to a master node (MgNB 402) and a secondary node (SgNB 408). However, only the MgNB 402 is connected to the CN. In this case, the MgNB 402 is a single point of failure in addition to the UE 102 and the AS.

In DC architecture option 1A, there are two separate connections to the CN (one from each access point). In this case, there are two redundant paths from the UE 102 to the AS. Only the UE 102 and the AS are single point of failures in this case.

In DC architecture, MN refer to the master mode (i.e. MgNB in NR and MeNB in LTE) and SN refers to the secondary node (i.e. SgNB in NR and SeNB and LTE). In CA architecture, MN and SN refer to Master Cell Group (MCG) and Secondary Cell Group (SCG), respectively.

### DC Architecture Option 1A

If the UPF is collocated with the AS then DC architecture option 1A can be used, where the MN 402 and SN 408 both have a connection to the same UPF. A highly reliable tunneling protocol, which does not increase latency, can be used between the MN 402/SN 408 and the UPF (e.g. QUIC or enhanced GTP-U). This case is illustrated in FIG. 23. In the example of FIG. 24, the UPF is co-located with the Application Server in an Edge Node.

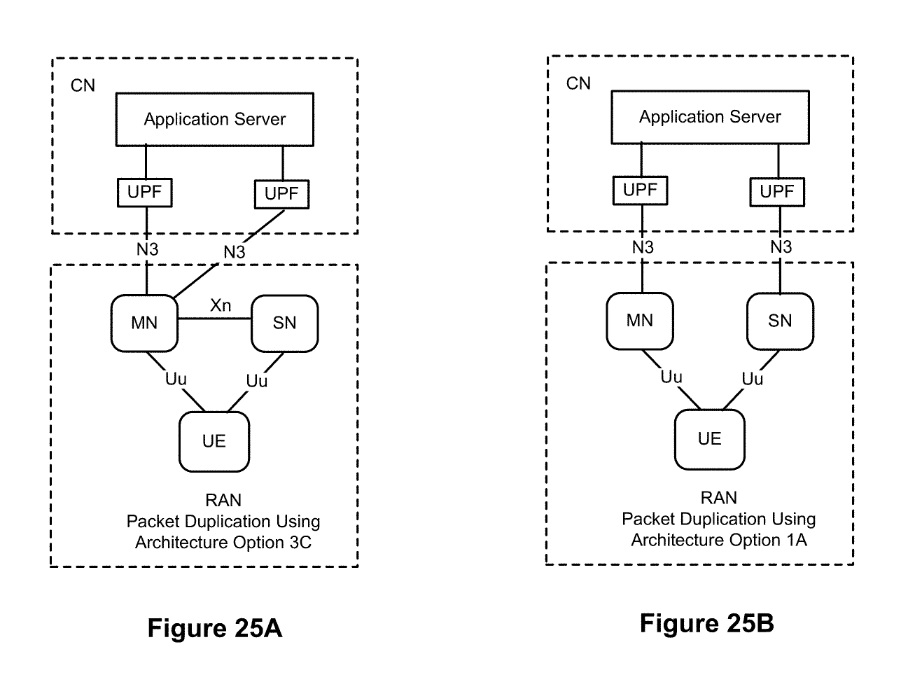

In embodiments in which the UPF is not collocated with the AS then it may be necessary to have separate UPFs for each path. Two architecture options for this case are illustrated in FIGS. 25A and 25B. The architecture of FIG. 25A is the DC architecture option 3C, where the MN 402 is hosting the PDCP entity and has a connection to the CN. The packets that are duplicated in the RAN are removed by the PDCP entity in the MN 402. If additional redundancy is required in the CN then the MN 402 should be able to send duplicate packets to the different UPFs. A packet duplication and removal function can be performed by the MN and the UPF. This function can be a part of the enhanced tunneling protocol between the two nodes.

The architecture illustrated in FIG. 25B is the DC architecture option 1A, where both the MN 402 and SN 408 have a connection to the CN through different UPFs. In this case, the packets that are duplicated in the RAN are not removed in the RAN. The duplicate packets are removed in the application in the AS and UE 102. Alternatively, the packet duplication and removal can be performed in the UE and the UPF.

### Option 1: Single UPF

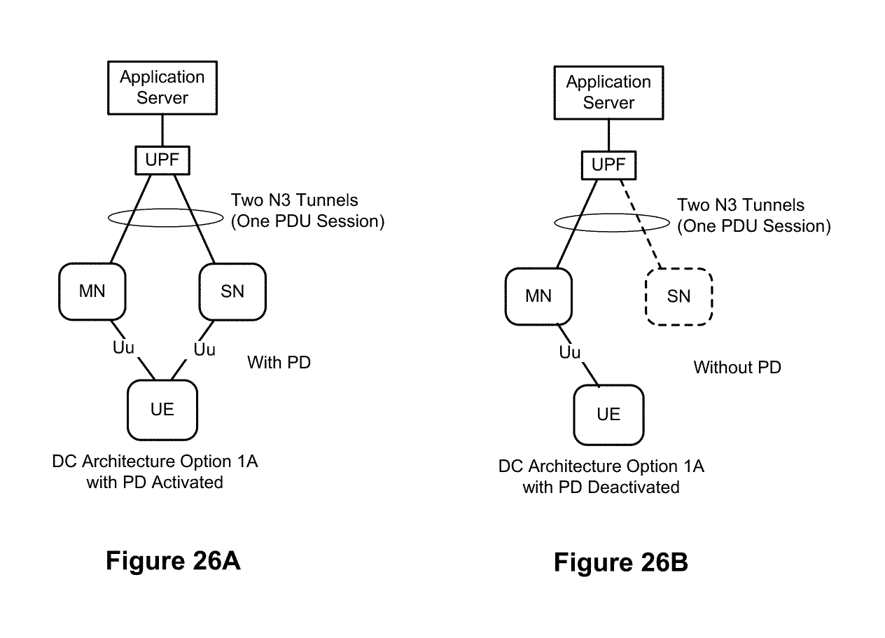

FIGS. 26A and 26B are a block diagrams illustrating Dynamic Control of Packet Duplication in DC Option 1A DC architecture Option 1A is already included in the SA2 specifications. This is used for load balancing, where some flows are sent to/from the MN 402 and the remaining flows are sent to/from the SN 408.

In order to support URLLC use cases, this option can be extended to support UL and DL packet duplication when the AS and the UPF are not collocated with the RAN node hosting the PDCP entity.

In this scenario, the UPF and the AS can be collocated at the edge node.

The UL packet duplication and removal can be performed at the UE 102 and UPF, respectively. Alternatively, the removal can be performed at the application in the AS.

The DL packet duplication and removal can be performed at the UPF and the UE 102, respectively. Alternatively, the packet duplication can be performed by the application in the AS.

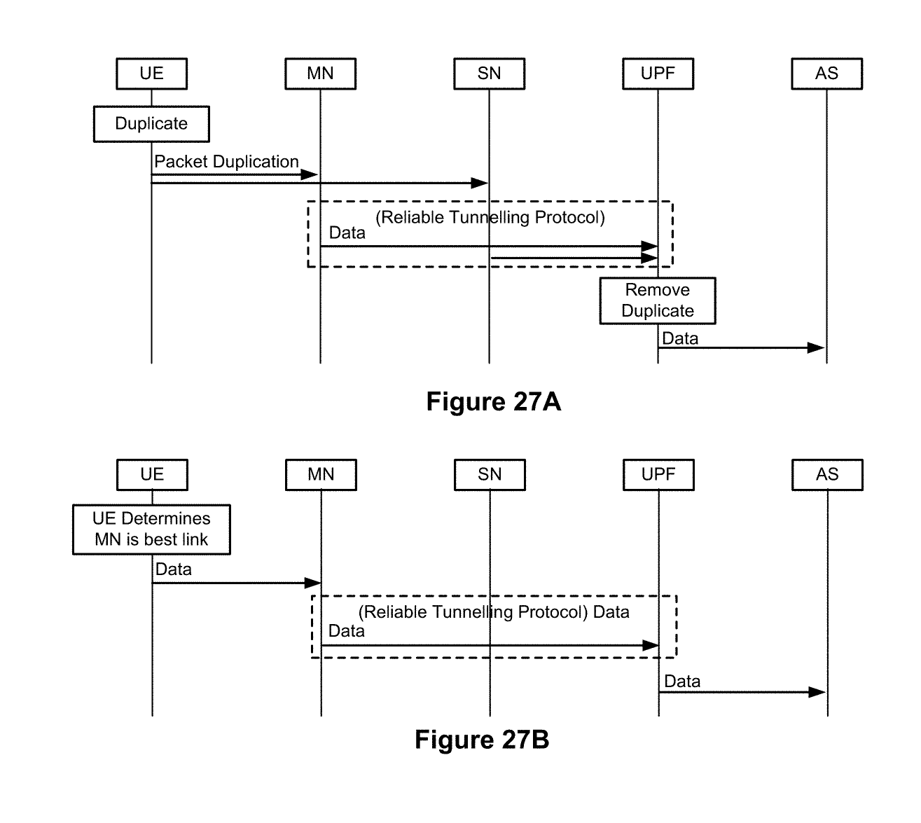

FIG. 27A illustrates UL data transmission with PD activated. In this case:
UE 102 duplicates PDCP SDUs or alternatively the UE can duplicate the IP packets at a layer above PDCP (e.g. a Packet Duplication/Removal (PD/R) layer).
UE 102 transmits packets to MgNB 402 and SgNB 408 using corresponding keys
MgNB 402/SgNB 408 forward the received packets to the UPF
UPF removes duplicates
UPF forwards packet to AS
Reliable tunneling protocol is used between MgNB 402/SgNB 408 and UPF (e.g. using autonomous retransmissions using different paths). For example, UDP based protocols such as enhanced GTP-U, SCTP, QUIC, etc. can be considered.

FIG. 27B illustrates UL data transmission with PD deactivated. In this case:
UE 102 transmits to only MgNB 402/SgNB 408
Receiving node forwards to UPF
UPF forwards to AS

Reliable tunneling protocol is used between MgNB 402/SgNB 408 and UPF (e.g. using autonomous retransmissions using different paths). For example, UDP based protocols such as enhanced GTP-U, SCTP, QUIC, etc. can be considered.

In an alternate embodiment, the packet duplication and removal can be performed in the AS instead of the UPF.

### DL MAC CE

DL MAC CEs are used to dynamically control UL packet duplication. Both the MN 402 and SN 408 send MAC CEs to indicate whether or not the UE 102 should use packet duplication. The decision by the MN 402/SN 408 is based on the UE 102's UL channel measurements. For example, if the UE 102's channel quality is below a predetermined or configured threshold then the node indicates to the UE 102 to activate PD. Each node can make the decision independently, without coordination. The same MAC CE structure can be used as in DC Architecture Option 3C.

It is UE 102 implementation on how to make the final decision when a conflict occurs between the MAC CEs from the MN 402 and SN 408. When the UE 102 activates/deactivates packet duplication, it does not have to inform the network.

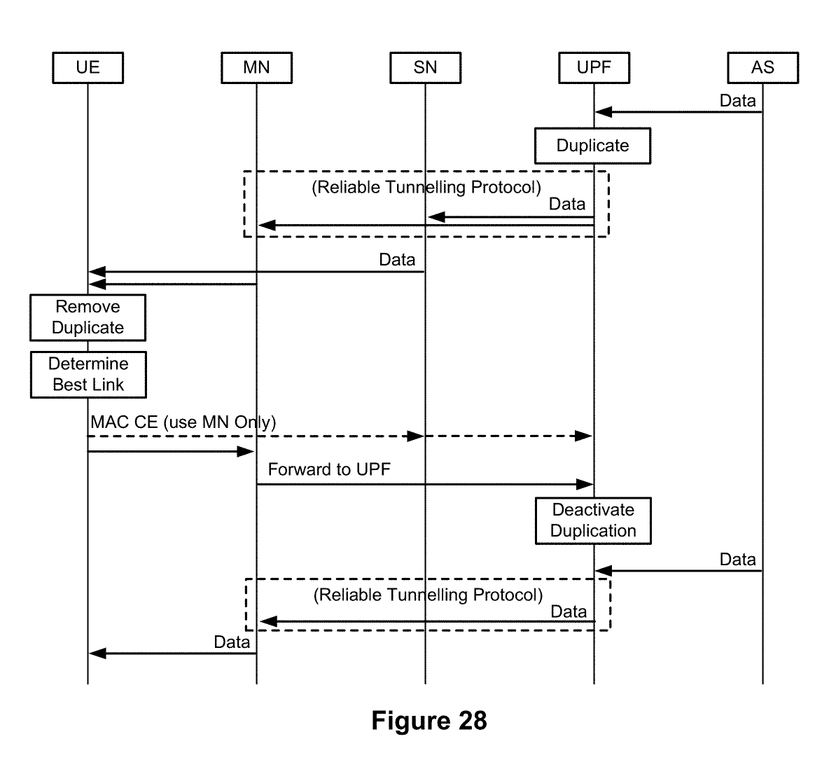

FIG. 28 is a message flow diagram illustrating an example of DL Transmission in DC Architecture 1A, with and without PD. When DL PD is activated:
UPF duplicates the IP packets
UPF forwards duplicate packets to the MN and SN. A reliable tunneling protocol can be used between the UPF and the MN/SN. For example, enhanced GTP-U, SCTP, QUIC, etc.
MN/SN transmit to the UE 102
The UE 102 removes the duplicate packets

On the other hand, when DL PD is deactivated:
UE 102 indicates the best link (i.e. MN or SN) to either MN/SN or both
The MN/SN or both nodes send the best link to the UPF. A reliable tunneling protocol can be used between the UPF and the MN/SN. For example, enhanced GTP-U, SCTP, QUIC, etc.
UPF sends the IP packets to the selected node (i.e. MN or SN)
The receiving node transmits to the UE 102

In an alternate embodiment, the packet duplication and removal can be performed in the AS instead of the UPF.

### UL MAC CE

The UE 102 can send the request for DL PD (or best link selection) using an UL MAC CE. Based on DL measurements of the MN and SN, the UE 102 can determine if PD is necessary or if the best link is the MN or SN.

The UE 102 can send the following in an UL MAC CE:
DL PD required
DL from MN
DL from SN

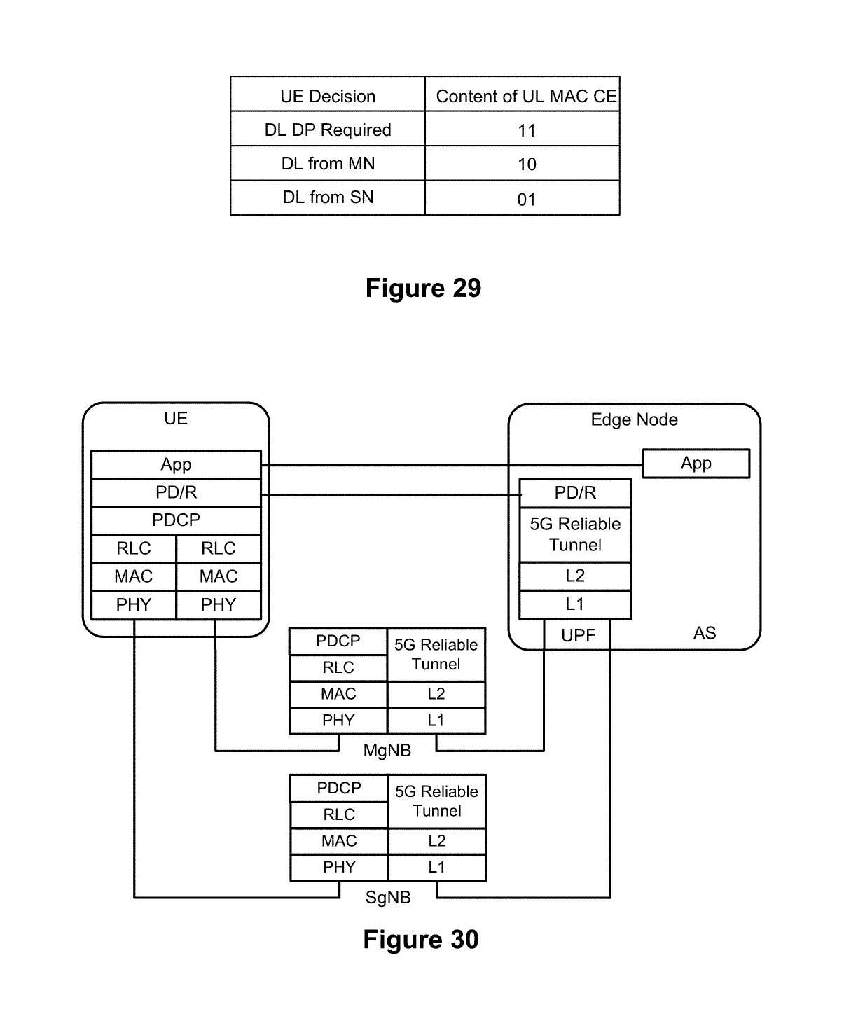

The contents of the UL MAC CE can be as set out in the table of FIG. 29. The MAC CE can also contain the DRB ID to indicate for which DRB the command applies. Alternatively, the MAC CE may be a bitmap, where each bit or set of bits corresponds to a DRB that is configured for packet duplication. The UE can send UL MAC CEs to the node hosting the PDCP or both.

### Protocol Stack for Reliable Transmission

A reliable protocol between the MgNB/SgNB and UPF is required. The protocol stack at the UE 102, gNB and UPF (at the edge node) for this solution is illustrated in FIG. 30.

The packet duplication and removal function can be performed by the UE 102 and the UPF. Alternatively, the function can be performed by the application in both the UE 102 and AS. This option is transparent to the RAN and the CN except for the mapping of the original and duplicate flows to different QFIs

If the function is performed by the UE 102 and UPF then the UE 102 can dynamically activate/deactivate UL packet duplication using the information contained in the DL MAC CEs for packet duplication. The UE 102 can also control DL packet duplication by using UL MAC CEs. Another benefit of performing the PD/R function in the UPF is that there are no duplicate flows over the N6 interface between the UPF and the AS, which can reduce the traffic load when there UPF and AS are not collocated.

### OFI Enhancements for URLLC

When performing packet duplication for URLLC, two QoS flows corresponding to the original flow (containing the original packet) and duplicate flow (containing the duplicate packet) may be generated. Here, each flow is indicated by a QoF flow identifier (QFI). In this case, the original QoS flow may be indicated by QFI(OF) and the duplicate flow may be indicated by QFI(DF). The differentiation between QFI(OF) and QFI(DF) can be done by using an extension bit to the existing QFI bit sequence. The extension bit indicates whether the flow is the original flow or duplicate flow. For example, QFI bit sequence 00011 may indicate the original flow (QFI(OF)) and QFI bit sequence 10011 may indicate the duplicate flow (QFI(DF)). Alternatively, the existing available sequence space or the set of bit sequences for QFI can be increased such the original and duplicate flows can be represented with different QFIs (e.g. Original flow is indicated as QFI1 and duplicate flow is indicated as QFI2). Note that in both cases, the QoS requirements that need to be satisfied by the RAN and Core Network by provisioning resources for the original and duplicate flows may be identical even when different QFIs are assigned to the QoS flows.

PDU Session Establishment Procedure for DC-1A with One UPF

When the UE 102 sends a PDU Session Request for a URLLC PDU Session, the existing PDU session establishment procedure can be used. However, when the RAN node (MN) receives the AN PDU request from the SMF via the AMF, the RAN node may initiate RRC Connection Reconfiguration signaling with the UE to establish RAN resources related to the QoS rules for the URLLC PDU Session request. This may include resources and QoS mapping for packet duplication. The QoS rules indicate which QFIs are mapped to the MN and SN (e.g. QFI(OF) is mapped to DRB(MN) and QFI(SN) is mapped to DRB(SN)). The RAN node (MN) also allocates the N3 tunnel information to the PDU Session (e.g. QFI(OF) is mapped to TEID(MN) and QFI(DF) is mapped to the TEID(SN)). This information is included in the AN Tunnel Info that is sent to the SMF via the AMF. The SMF sends the AN Tunnel Info and the forwarding rules to the UPF. The N3 tunnel may be configured with a reliable tunneling protocol (e.g. QUIC based protocol instead of UDP based or an enhanced version of GTP-U).

The MN can assign a duplicate flow with a flow ID QFI to the SN and add the N3 tunnel endpoint ID for the SN to the AN tunnel info. In this case, the URLLC PDU session has two N3 tunnels, one to/from the MN and one to/from the SN.

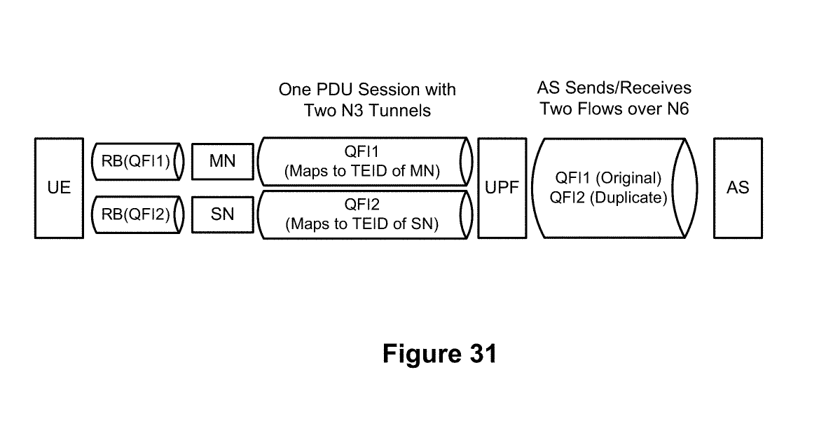

The mapping of the original flow (QFI1) and the duplicate flow (QFI2) to the MN and SN is illustrated in FIG. 31.

If the RAN node configures the UE with DC(1A) after a PDU session is established then the RAN node can use the PDU Session Modification procedure to add the SN TEID to the AN Tunnel Info and update the forwarding rules. In this case, the same steps for QoS mapping and allocating AN Tunnel Info can be used as in the PDU Session Establishment procedure.

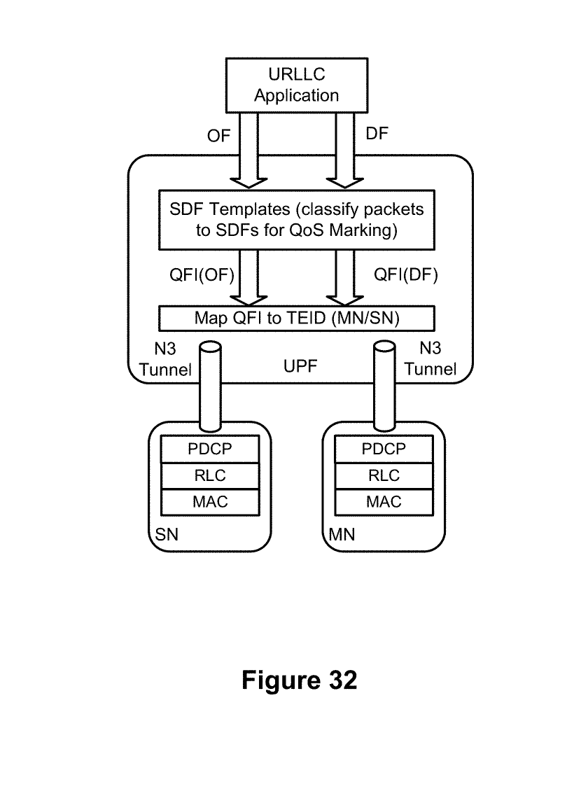

For DL transmission, in one embodiment, the AS sends duplicate flows to the UPF. At the UPF, the SDF templates are used to classify the application data packets to SDFs for QoS marking. For duplicate flows, the original flow and the duplicate flow are marked with different QFIs. For example, the original flow is marked as QFI(OF) and the duplicate flow is marked as QFI(DF). The UPF then maps the QFI(OF) to the TEID of the MgNB and QFI(DF) to the TEID of the SN. The SDAP in the MN and SN map the QFI to a DRB for delivery to the UE 102. The application in the UE 102 is responsible for removing duplicate packets. The DL procedure is illustrated in FIG. 32.

In another embodiment, the AS sends a single URLLC flow to the UPF and the UPF is responsible for creating a duplicate flow.

The Policy Control Function (PCF) is responsible for providing the QoS rules to the UPF via the SMF for classifying packets to SDFs for QoS marking. The PCF also provides QoS rules for the UE 102 to map the duplicate flows to different QoS flows with distinct QFI markings.

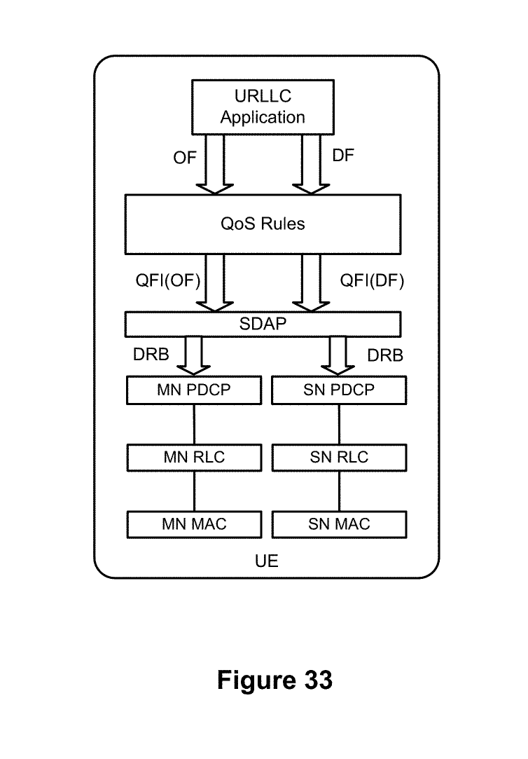

For UL transmission, the SMF provides the QoS rules to the UE 102 through a NAS message. The QoS rules are used in the Non-Access Stratum (NAS) layer to map the UL data packet from applications (e.g. IP flows) to QoS flows and for applying the QFI marking. The SDAP entity in the UE 102 maps the QFI to a DRB. For example, the SDAP maps the original flow, QFI(OF) to a DRB associated with the MN and the duplicate flow, QFI(DF) to a DRB associated with the SN. The MN and SN send the corresponding flow to the UPF. The UPF sends both received flows to the AS. The AS removes the duplicate application packets. The UL procedure is illustrated in FIG. 33.

For UL transmission, when the UL data packets are duplicated in the application layer, both the original and duplicate packet may have identical parameters in the packet header (e.g. TCP/IP sequence numbers, bit rate indicator). The QoS rules, obtained via the NAS message, to handle duplicate packets may provide the packet filters to classify packets with same parameters in the packet headers to different QoS flows, each with a distinct QFI marking. For example, the QoS rule may indicate that if two packets with the same parameters in the packet headers are received within a certain time interval in the UE's NAS layer, each of these packets are mapped to two different QoS flows with markings QFI(OF) and QFI(DF). Subsequently, in the SDAP layer the QFI markings are used to map the QoS flows to different DRBs corresponding to the MN and SN. In this case, the RAN has to configure the SDAP in UE through RRC to adhere to the QFI-to-DRB mapping rule for handling the UL duplicate QoS flows. Specifically, certain mapping restrictions may be included in SDAP to ensure that QoS flows with certain QFI markings are mapped to different DRBs. For example, the configuration in SDAP may indicate that the markings QFI(OF) and QFI(DF) are mapped to DRB1(MN) and DRB2(SN). In the RAN (i.e. MN and SN), the markings QFI(OF) and QFI(DF) are used to select the corresponding N3 tunnels based on the QoS mapping rules provided by the SMF via N2 to MN and SN during PDU session establishment/modification procedure.

If the packet duplication and removal function is performed at the layer below the application layer (e.g. within the NAS layer) then the PD/R function is responsible for assigning different QFIs to the two flows (i.e. original flow and duplicate flow). The SDAP layer is responsible for mapping the two QFIs to different DRBs.

If packet duplication is no longer required the RAN, but still required in the CN, the MN can send a PDU session modification request to the SMF via the AMF to remove the tunnel endpoint of the SN. The MN can provide another tunnel endpoint corresponding to the MN to ensure reliability in the CN (i.e. both flows (original and duplicate are sent to the MN for reliability).

### Packet Duplication and Removal Function

The packet duplication and removal protocol can be between the UE 102 and the UPF or between the UE and AS. Both the UPF and the AS can be collocated at an edge node.

In the case where the PD/R function is located within the application, the PD/R function, at the transmitter, receives an application packet from the application layer, duplicates the packet and adds a header with a sequence number to both packets. It may also add a bit to indicate whether the packet is the original or duplicate flow. The sequence number is used by the receiver to identify duplicate packets. At the receiver, the PD/R protocol uses the sequence number to provide in order delivery of the application packets to the application in addition to removing the duplication application packets.

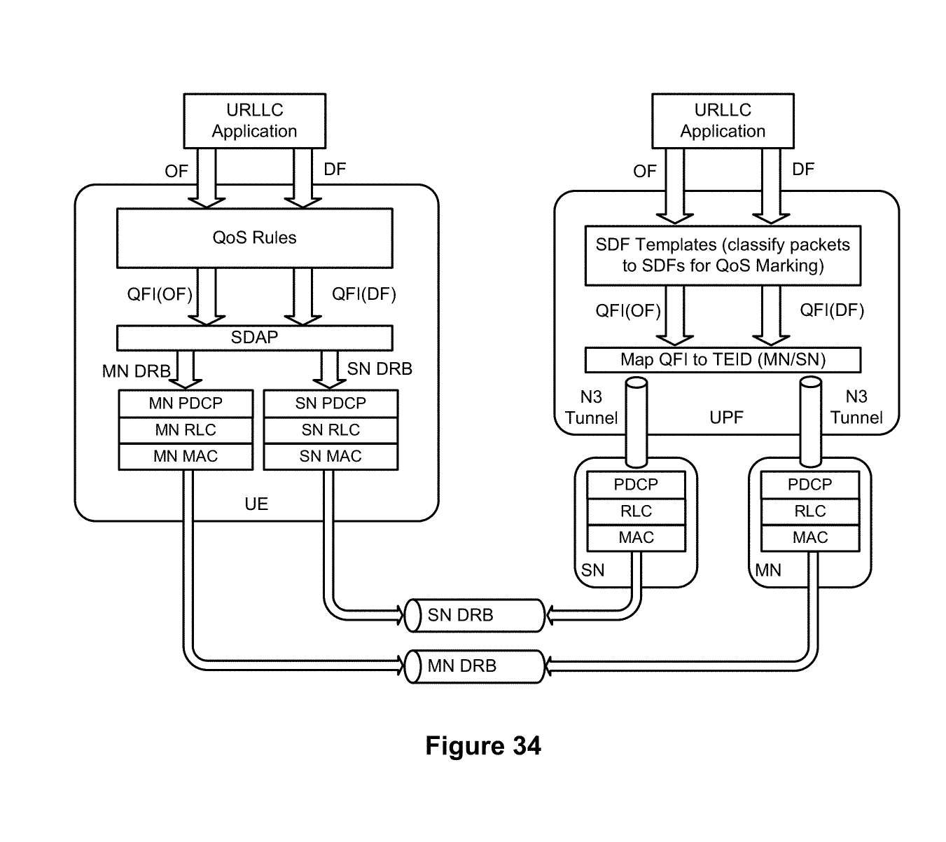

The case where the packet duplication and removal function is performed by the application in the UE 102 and AS is illustrated in FIG. 34.

Alternatively, the duplication and removal function can be located in both the UPF and the NAS layer in the UE 102 rather than at the application in the UE 102 and AS. In this case, for DL traffic, the UPF duplicates the traffic before the SDF templates are applied. For UL traffic, the UE 102 duplicates the traffic before the QoS rules are applied.

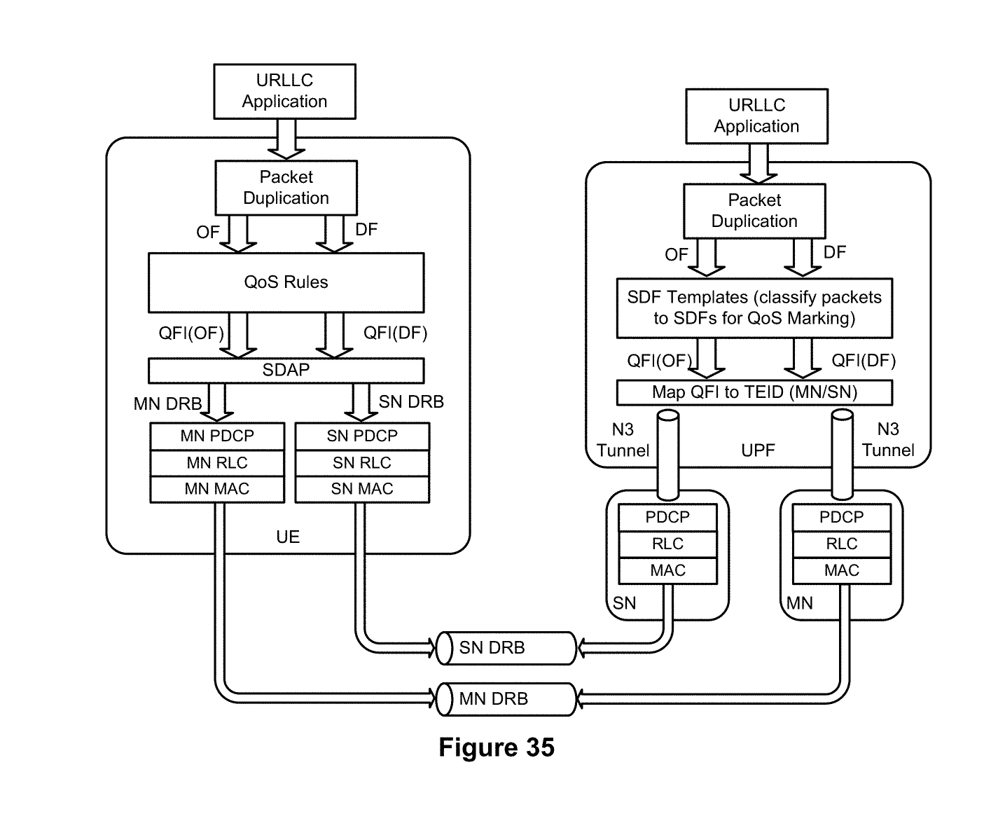

The case where the packet duplication and removal function is performed by the UE 102 and UPF is illustrated in FIG. 35.

### Option 2: Multiple UPFs

In this option, multiple UPFs are used for redundant transmission to form two independent paths between the UE 102 and the AS.

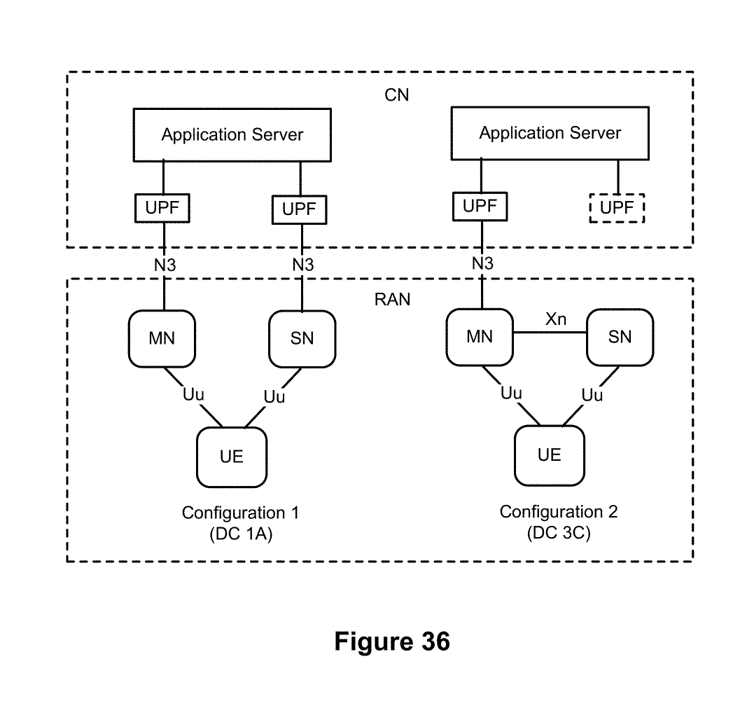

FIG. 36 illustrates two configurations using two UPFs and DC-1A and one UPF using DC-3C, respectively.

Configuration 1 can be used to improve the reliability in both the RAN and the CN. Configuration 2 can be used to improve the reliability in RAN. In this case, it is assumed that the reliability in the CN can be satisfied with a single UPF. In both cases, a reliable tunneling protocol can be used between the MN/SN and the UPF to ensure that the reliability in the CN is satisfied.

In configuration 1, if packet duplication is deactivated in the RAN then the only one UPF is used. In this case it may be necessary to activate packet duplication in the RAN when the CN reliability cannot be satisfied with a single UPF. Configuration 1 can be used when dynamic control of packet duplication is not required (i.e. packet duplication is always activated).

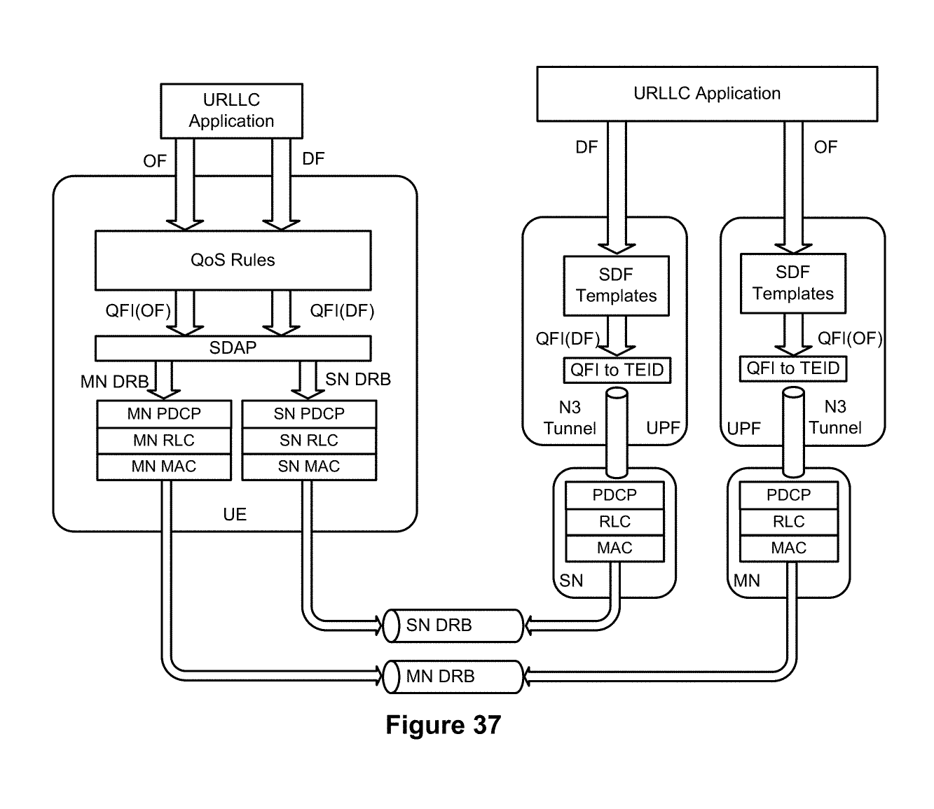

The procedure for the transmitting entities is illustrated in FIG. 37.

In this approach, the applications in the UE 102 and the AS are responsible for packet duplication and removal.

The same UE 102 architecture can be used as in the case where there is only one UPF and the application in the UE 102 is responsible for packet duplication and removing.

### PDU Session Establishment and Modification

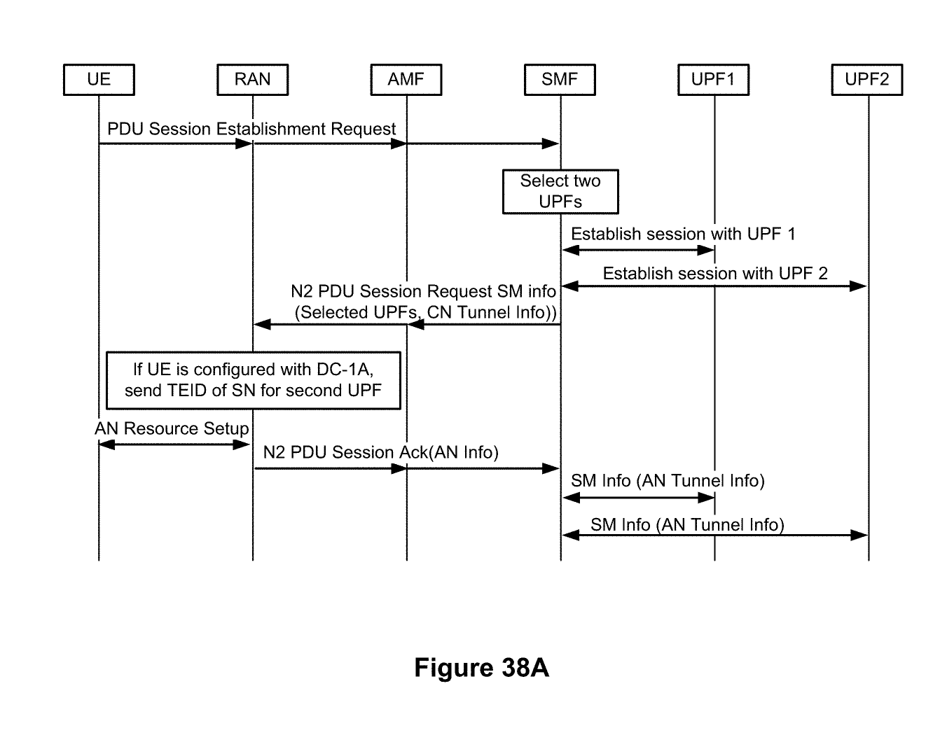

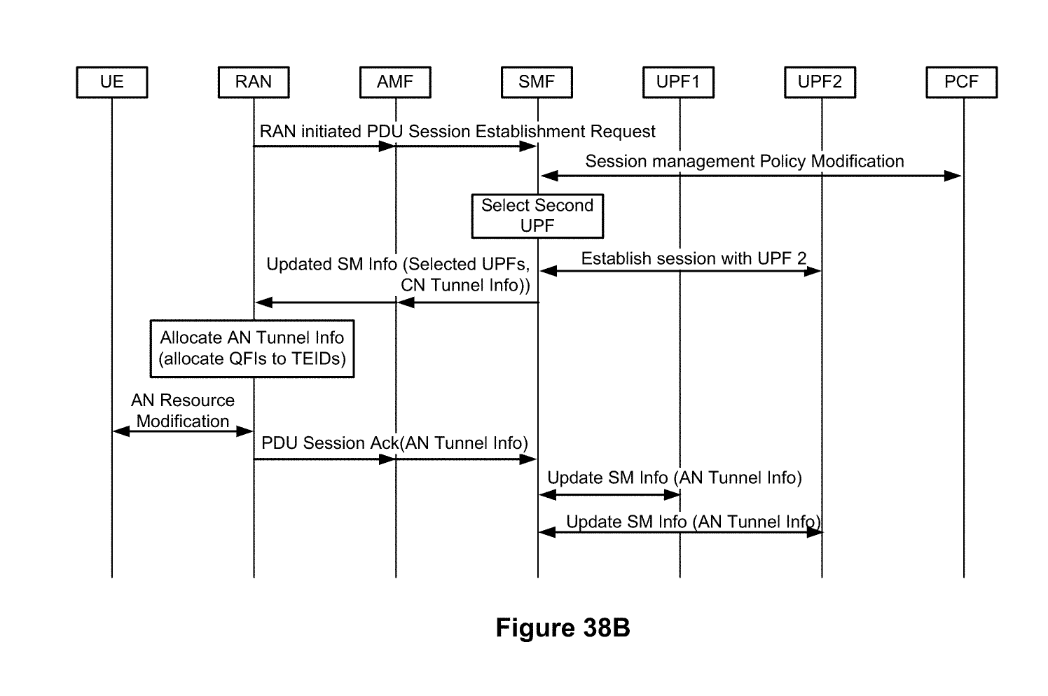

FIGS. 38A and 38B are message flow diagrams illustrating example processes for PDU session establishment and modification, respectively. When the UE 102 sends a PDU session establishment request for a URLLC application, the SMF may select two UPFs for providing resilience to node (i.e. UPF) failures. In this case, the PDU session contains two UPF and two N3 tunnels from the individual UPFs to the MN and SN, respectively. The UPFs should be selected to ensure that the latency and reliability requirements are satisfied for the requested service.

In the UE initiated PDU Session Establishment procedure, shown in FIG. 38A, the PDU Session Establishment Request for a URLLC application is sent by the UE to the SMF through the RAN and AMF. Based on the PDU Session Establishment Request, which may contain the requirement to satisfy high reliability using two UPFs for duplicate/redundant transmission, the SMF selects two UPFs (e.g. UPF1 and UPF2). This is followed by establishing and configuring of the selected UPF1 and UPF2 with the information (e.g. PDU Session ID, QoS rules for QFI marking, SDF templates) for handling the traffic flow related to the PDU Session. The UPFs, in turn, provide the CN side tunnel related information (i.e. IP addresses, TEIDs) to the SMF. Next, the SMF sends an N2 PDU Session Request containing the SM info (i.e. selected UPFs, CN Tunnel Info, QoS rules for QFI marking, QFI-to-TEID mapping) to the RAN through the AMF. The RAN identifies the TEID corresponding to the MN for the first N3 tunnel linking the MN (e.g. MgNB) and UPF1 (i.e. TEID-MN to TEID-UPF1). If the UE is configured with DC-1A, the RAN also identifies the TEID corresponding to the SN (e.g. SgNB) for the second N3 tunnel linking the SN and UPF2 (i.e. TEID-SN to TEID-UPF2). For supporting duplicated/redundant transmission, the RAN may determine and assign the QFI of the original flow to the MN (e.g. QFI(OF)-MN) and assign the QFI of the duplicate flow to the SN (e.g. QFI(DF)-SN). In the N2 PDU Session Response, the RAN provides the RAN side N3 tunnel information (i.e. TEIDs corresponding to the MN and SN) to the SMF. Based on the received RAN side N3 tunnel information, the SMF configures UPF1 with the TEID corresponding to MN (i.e. TEID-UPF1 to TEID-MN for QFI(OF)) and UPF2 with the TEID corresponding to the SN (i.e. TEID-UPF2 to TEID-SN for QFI(DF)). In the RAN, the MN, SN and UE are configured with the data radio bearers (DRBs) and the mapping rules between DRBs and QFI to support the established PDU session.

In the PDU session establishment procedure, the SMF selects two UPFs and sends the information to the AMF to forward to the RAN. If the RAN determines that packet duplication is required in the RAN and the UE 102 is configured with DC architecture 1A then the RAN can include the tunnel endpoint ID (TEID) to the SMF via the AMF. The SMF then establishes two separate N3 tunnels to the MN and SN (e.g. between UPF1 and MN and UPF2 and SN). Both N3 tunnels belong to the same PDU session.

The message from the SMF to the AMF should be updated as follows:
SMF to AMF: Namf_Communication_N1N2MessageTransfer (PDU Session ID, Access Type, N2 SM information (PDU Session ID, QFI(s), QoS Profile(s), CN Tunnel Info, S-NSSAI, Session-AMBR, PDU Session Type), N1 SM container (PDU Session Establishment Accept (QoS Rule(s), selected SSC mode, S-NSSAI, allocated IPv4 address(es), interface identifier, Session-AMBR, selected PDU Session Type))). In case of multiple UPFs are used for the PDU Session (connected a N9 interface), the CN tunnel Info contain tunnel information related with the UPF that terminates N3. In the case of dual connectivity with two UPFs and two N3 tunnels, the CN tunnel Info contains tunnel information for both UPFs.

If packet duplication is no longer required in the RAN, but still required in the CN, the MN can send a PDU session modification request to the SMF via the AMF to remove the tunnel endpoint of the SN. The MN can provide the MN TEID or another tunnel endpoint corresponding to the MN to ensure reliability in the CN (i.e. both flows (original and duplicate are sent to the MN from two different UPFs for reliability).

If the PDU session was initially established with one UPF then a second UPF may be added to the existing PDU session when the RAN decides that the QoS targets for the QoS flow cannot be fulfilled. This may result in a RAN initiated PDU Establishment/Modification request sent by RAN to SMF through AMF as shown in FIG. 38B. In this case, the SMF may report the event to the PCF and the PCF may provide the new policy to the SMF. The new policy may be to add another UPF for redundant transmission (i.e. to the same tunnel endpoint or to two different endpoints. The SMF selects another UPF and updates the CN tunnel info with the new UPF using the N4 session modification procedure with the selected UPF. The selected UPF, in turn, provides the CN side tunnel related information (i.e. IP address, TEID) to the SMF. The SMF then sends the updated SM information, which includes the updated CN tunnel info, to the AMF. The AMF the forwards this to the RAN. In case of dual connectivity, the RAN decides which QFIs are allocated to the MN and SN (e.g. the original flow may be assigned to the MN and the duplicate flow may be assigned to the SN). The RAN sends the updated AN tunnel info to the SM via the AMF. The AN tunnel info may include the tunnel endpoints of the MN and SN, where the MN and SN are associated with different UPFs.

### Redundancy in the UE 102 and AS

Redundancy can compensate for node failures as well as link failures. The UE 102 and the AS can be considered nodes in the E2E path. Both the UE 102 and AS can be a single point of failure. Fault management techniques may be required at all nodes in order to satisfy the E2E reliability requirements. If the reliability of the UE 102 and AS are considered, it may be necessary to duplicate the UE 102 and AS to ensure that there is no single point of failure. In this case, multiple instances of the UE 102 and AS functions can be instantiated on separate nodes. The multiple instances should be synchronized. Stateless functions can be used, where the state information is stored externally. This reduces the synchronization effort to only the storage of the state information.

Based on the forgoing, it may be seen that embodiments of the present invention may provide:
A method at User Equipment (UE 102) for controlling packet duplication of a Radio Access network (RAN) having DC architecture, the method comprising:
   receiving, via at least one network interface of the User Equipment, information indicative of an event triggered at a master node and an event triggered at a secondary node; and
   performing packet duplication contingent on the received information, and reliability requirements.
A method at User Equipment (UE 102) for controlling packet duplication of a Radio Access network (RAN) having CA architecture, the method comprising:
   receiving, via at least one network interface of the User Equipment, information indicative of an event triggered at a node; and
performing packet duplication contingent on the received information.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method at a User Equipment (UE) of a network, the method comprising:
receiving a packet duplication (PD) control element from one or more nodes of the network; and
controlling activation and deactivation of PD in response to the control element.

2. The method as claimed in claim 1, wherein:
PD is in respect of a PDCP Protocol Data Unit (PDU) associated with the UE.

3. The method as claimed in claim 1, wherein:
the one or more nodes of the network comprises a master node (MgNB); and
the control element is received from the MgNB.

4. The method as claimed in claim 1, wherein:
the one or more nodes of the network comprises a secondary node (SgNB); and
the control element is received from the SgNB.

5. The method as claimed in claim 1, wherein the control element is a Media Access Control-Control Element (MAC-CE) message.

6. The method as claimed in claim 1, wherein the PD is associated with a Data Radio Bearer (DRB).

7. The method as claimed in claim 1, wherein the PD is in dual connectivity (DC) architecture.

8. The method as claimed in claim 1, wherein the PD is in Carrier Aggregation (CA) architecture.

9. The method as claimed in claim 1, wherein the PD is on different carriers.

10. The method as claimed in claim 7, wherein the one or more nodes of the network comprises a master node (MgNB) and a secondary node (SgNB).

11. The method as claimed in claim 10, wherein the master node (MgNB) and secondary node (SgNB) send independent control elements.

12. The method as claimed in claim 10, wherein the master node (MgNB) and secondary node (SgNB) send the same control elements.

13. The method as claimed in claim 10, wherein the master node (MgNB) and secondary node (SgNB) share PDCP functionality.

14. The method as claimed in claim 10, wherein the master node (MgNB) and secondary node (SgNB) each have PDCP functionality.

15. The method as claimed in claim 7, further comprising, on deactivation of PD, employing existing multiple channels as a split bearer.

16. The method as claimed in claim 8, further comprising, on deactivation of PD, employing normal CA operation.

17. A User Equipment (UE) for connection to a network, the UE comprising:
at least one processor;
a non-transitory storage medium including software instructions configured to receive a packet duplication (PD) control element from one or more nodes of the network; and control activation and deactivation of PD in response to the control element.

18. The UE as claimed in claim 17, wherein PD is in respect of a PDCP Protocol Data Unit (PDU) associated with the UE.

19. The UE as claimed in claim 17, wherein the one or more nodes of the network comprises a master node (MgNB); and the control element is received from the MgNB.

20. The UE as claimed in claim 17, wherein the one or more nodes of the network comprises a secondary node (SgNB); and the control element is received from the SgNB.

21. The UE as claimed in claim 17, wherein the control element is a Media Access Control-Control Element (MAC-CE) message.

22. The UE as claimed in claim 17, wherein the PD is in dual connectivity (DC) architecture.

23. The UE as claimed in claim 17, wherein the PD is in Carrier Aggregation (CA) architecture.

24. The UE as claimed in claim 17, wherein the PD is on different carriers.

25. The method as claimed in claim 22, wherein the one or more nodes of the network comprises a master node (MgNB) and a secondary node (SgNB).

26. The UE as claimed in claim 25, wherein the master node (MgNB) and secondary node (SgNB) send independent control elements.

27. The UE as claimed in claim 25, wherein the master node (MgNB) and secondary node (SgNB) send the same control elements.

28. The UE as claimed in claim 25, wherein the master node (MgNB) and secondary node (SgNB) share PDCP functionality.

29. The method as claimed in claim 25, wherein the master node (MgNB) and secondary node (SgNB) each have PDCP functionality.

30. The method as claimed in claim 22, further comprising, on deactivation of PD, employing existing multiple channels as a split bearer.

31. The method as claimed in claim 23, further comprising, on deactivation of PD, employing normal CA operation.
